(19) United States
(12) Patent Application Publication
(10) Pub. No.: US 2026/0274335 A1
(43) Pub. Date: Sep. 17, 2026

(54) METHOD AND APPARATUS FOR AUTOMATIC TURNING WITH RECORDING

(71) Applicant: MTD PRODUCTS INC, Valley City, OH (US)

(72) Inventors: Zachary A. Lyzen, Seattle, WA (US); Adam J. Woodrum, Wakeman, OH (US); Katharin Jensen-Nau, Crystal, MN (US)

(21) Appl. No.: 19/569,533

(22) Filed: Mar. 17, 2026

Related U.S. Application Data
(60) Provisional application No. 63/772,958, filed on Mar. 17, 2025.

(51) Int. Cl. B62D 6/00; A01B 69/04; A01D 34/00

(52) U.S. Cl. CPC B62D 6/002; A01B 69/008; B62D 6/001; A01D 34/008

(57) ABSTRACT

Provided is an automatic module for a power equipment device, comprising a user input; a first computer; and a steering controller. The user input may be configured for receiving an turn command related to turning. The first computer may be coupled to the user input, configured to access a stored record of operator turn command data, configured to create the emulation, and configured to output the emulation. The steering controller may be coupled to the computer and configured to receive the emulation. The steering controller may comprise a computer configured for generating a series of turning signals based on the emulation and causing a steering apparatus of the power equipment device to move the power equipment device to execute a turn corresponding to the turn command.

### CROSS-REFERENCE TO RELATED APPLICATIONS

The application for patent claims the benefit of priority of U.S. Provisional Patent Application 63/772,958 entitled METHOD AND APPARATUS FOR AUTOMATIC TURNING WITH RECORDING, and filed Mar. 17, 2025, which is hereby incorporated by reference herein in its entirety and for all purposes.

### INCORPORATION BY REFERENCE

The following are hereby incorporated by reference within the present disclosure in their respective entireties and for all purposes: U.S. Pat. No. 11,623,689 issued Apr. 11, 2023, U.S. Pat. No. 9,409,596 issued Aug. 9, 2016; U.S. Pat. No. 9,944,316 issued Apr. 17, 2018.

### FIELD OF DISCLOSURE

The disclosed subject matter pertains to apparatuses and methods for automated turning of a power equipment, for instance, utilizing relative vehicle data for implementing a limited automated turn for a power equipment device.

Manufacturers of power equipment for outdoor maintenance applications offer many types of machines for general maintenance and mowing applications. Generally, these machines can have a variety of forms depending on application, from general urban or suburban lawn maintenance, rural farm and field maintenance, to specialty applications. Even specialty applications can vary significantly, from sporting events requiring moderately precise turf, such as soccer fields or baseball outfields, to events requiring very high-precision surfaces such as golf course greens, tennis courts and the like.

Automated vehicle technology has been introduced in test environments in recent years. Many manufacturers have engaged in the effort to produce a reliable, automated driving car and truck. While road vehicles have particular challenges, including differing types of roads and the variance in vehicle density typically observed for the different types of roads, extension of automated driving technology to off-road equipment often presents different challenges. Operator assist systems, for instance, are one category of emerging technologies that are becoming more prevalent for partial automation of off-road vehicle equipment.

It remains desirable to develop operator assist systems for power equipment comprising a method and apparatus for automatic turning with recording.

### BRIEF SUMMARY

The following presents a simplified summary in order to provide a basic understanding of some aspects of the disclosure. This summary is not an extensive overview of the disclosure. It is not intended to identify key/critical elements or to delineate the scope of the disclosure. Its sole purpose is to present some concepts of the disclosure in a simplified form as a prelude to the more detailed description that is presented later.

In a first embodiment, disclosed is an automatic turning and recording module for a power equipment device, comprising a user input; a first computer; and a steering controller. The user input may be configured for receiving a turn command related to turning, and configured for receiving a record command causing creation of a record sufficient to create an emulation of the turn command. The first computer may be coupled to the user input, configured to receive the record command, configured to create the record, configured to create the emulation, and configured to output the emulation. The steering controller may be coupled to the computer and configured to receive the emulation. The steering controller may comprise a computer configured for generating a series of turning signals based on the emulation and causing a steering apparatus of the power equipment device to move the power equipment device to execute a turn corresponding to the turn command.

To accomplish the foregoing and related ends, certain illustrative aspects of the disclosure are described herein in connection with the following description and the drawings. These aspects are indicative, however, of but a few of the various ways in which the principles of the disclosure can be employed and the subject disclosure is intended to include all such aspects and their equivalents. Other advantages and features of the disclosure will become apparent from the following detailed description of the disclosure when considered in conjunction with the drawings.

### BRIEF DESCRIPTION OF THE DRAWINGS

FIG. 1 depicts a block diagram of an example system that provides user-assisted automated turning for a power equipment device, in disclosed embodiments;

FIG. 2 illustrates a block diagram of a sample control unit for generating direction control of a power equipment device to facilitate automated turning, in an aspect(s);

FIG. 3 depicts a block diagram of an example power equipment device and user-assisted automated turning apparatus according to one or more embodiments herein;

FIG. 4 illustrates a diagram of an example power equipment device and smooth and continuous turn from a current path to a subsequent path, in an embodiment(s);

FIG. 5 depicts a diagram of an example heading determination for controlling an automated turn for a power equipment device in still further embodiments;

FIG. 6 depicts a smooth and continuous turn for a power equipment device larger than a track width of the device, in one or more aspects of the disclosed embodiments;

FIG. 7 illustrates a smooth and continuous turn for a power equipment device smaller than the track width of the device, in yet other disclosed aspects;

FIG. 8 depicts an example wheel path for a smooth and continuous turn smaller than a track width of a power equipment device configured for low radius turning;

FIG. 9 illustrates an example multi-segment automated turn into a leftward turn direction according to one or more embodiments;

FIG. 9A illustrates an example multi-segment automated turn into a rightward turn direction according to additional embodiments;

FIG. 10 depicts an example multi-segment automated turn including a first turning segment and a low radius turning segment in yet another embodiment(s);

FIG. 11 illustrates a sample method for providing automated turning of a power equipment device in response to input at a user input device according to further embodiments;

FIG. 12 depicts a sample method for performing a multi-stage automated turn for a power equipment device for operator-assisted autonomous turning, in an embodiment(s).

FIG. 13 depicts a block diagram of an example system that provides user-assisted automated turning for a power equipment device, in disclosed embodiments;

FIG. 14 depicts a processing system and accessories in one aspect of the present method and apparatus.

FIG. 15 depicts a block diagram representing an automatic turning and recording module in one aspect of the present method and apparatus.

FIG. 16 depicts a set of images representing four types of three-segment compound turns in one aspect of the present method and apparatus.

It should be noted that the drawings are diagrammatic and not drawn to scale. Relative dimensions and proportions of parts of the figures have been shown exaggerated or reduced in size for the sake of clarity and convenience in the drawings. The same reference numbers are generally used to refer to corresponding or similar features in the different embodiments, except where clear from context that same reference numbers refer to disparate features. Accordingly, the drawings and description are to be regarded as illustrative in nature and not as restrictive.

While embodiments of the disclosure pertaining to a method and apparatus for automatic turning with recording are described herein, it should be understood that the disclosed machines, electronic apparatus and computing devices and methods are not so limited and modifications may be made without departing from the scope of the present disclosure. The scope of the machines, apparatuses, methods, and electronic and computing devices for limited automated turning are defined by the appended claims, and all devices, processes, and methods that come within the meaning of the claims, either literally or by equivalence, are intended to be embraced therein.

### DETAILED DESCRIPTION

The following terms are used throughout the description, the definitions of which are provided herein to assist in understanding various aspects of the subject disclosure.

As used in this application, the terms “outdoor power equipment”, “outdoor power equipment machine”, “power equipment”, “maintenance machine” and “power equipment machine” are used interchangeably and are intended to refer to any of robotic, partially robotic ride-on, walk-behind, sulky equipped, autonomous, semi-autonomous (e.g., user-assisted automation), remote control, or multi-function variants of any of the following: powered carts and wheelbarrows, lawn mowers, lawn and garden tractors, lawn trimmers, lawn edgers, lawn and leaf blowers or sweepers, hedge trimmers, pruners, loppers, chainsaws, rakes, pole saws, tillers, cultivators, aerators, log splitters, post hole diggers, trenchers, stump grinders, snow throwers (or any other snow or ice cleaning or clearing implements), lawn, wood and leaf shredders and chippers, lawn and/or leaf vacuums, pressure washers, lawn equipment, garden equipment, driveway sprayers and spreaders, and sports field marking equipment.

As utilized herein, relative terms or terms of degree such as approximately, substantially, about, roughly and so forth, are intended to incorporate ranges and variations about a qualified term reasonably encountered by one of ordinary skill in the art in fabricating or compiling the embodiments disclosed herein, where not explicitly specified otherwise. For instance, a relative term can refer to ranges of manufacturing tolerances associated with suitable manufacturing equipment (e.g., injection molding equipment, extrusion equipment, metal stamping equipment, and so forth) for realizing a mechanical structure from a disclosed illustration or description. In some embodiments, depending on context and the capabilities of one of ordinary skill in the art, relative terminology can refer to a variation in a disclosed value or characteristic, e.g., a 0 to five-percent variance or a zero to ten-percent variance from precise mathematically defined value or characteristic (which is included in the range), or any suitable value or range there between can define a scope for a disclosed term of degree. As an example, a power equipment device can have an operating dimension, such as a heading measurement, average velocity estimate, relative position estimate, or the like, with a variance of 0 to five percent or 0 to ten percent. As another example, a disclosed mechanical dimension can have a variance of suitable manufacturing tolerances as would be understood by one of ordinary skill in the art, or a variance of a few to several percent about the disclosed mechanical dimension that would also achieve a stated purpose or function of the disclosed mechanical dimension. These or similar variances can be applicable to other contexts in which a term of degree is utilized herein such as relative position of a disclosed element, speed of a disclosed motor in rotations per minute (or other suitable metric), accuracy of measurement of a physical effect (e.g., a heading measurement, an acceleration measurement, a relative velocity, etc.) or the like. In addition to the foregoing, it should be understood that the drawings appended to this specification are not drawn to scale, unless explicitly stated in the description herein or on the drawing.

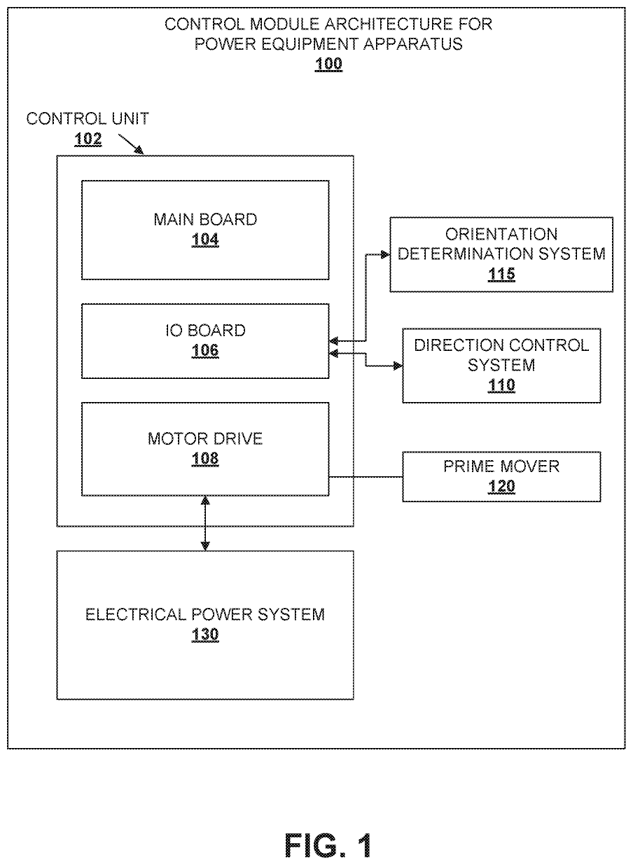

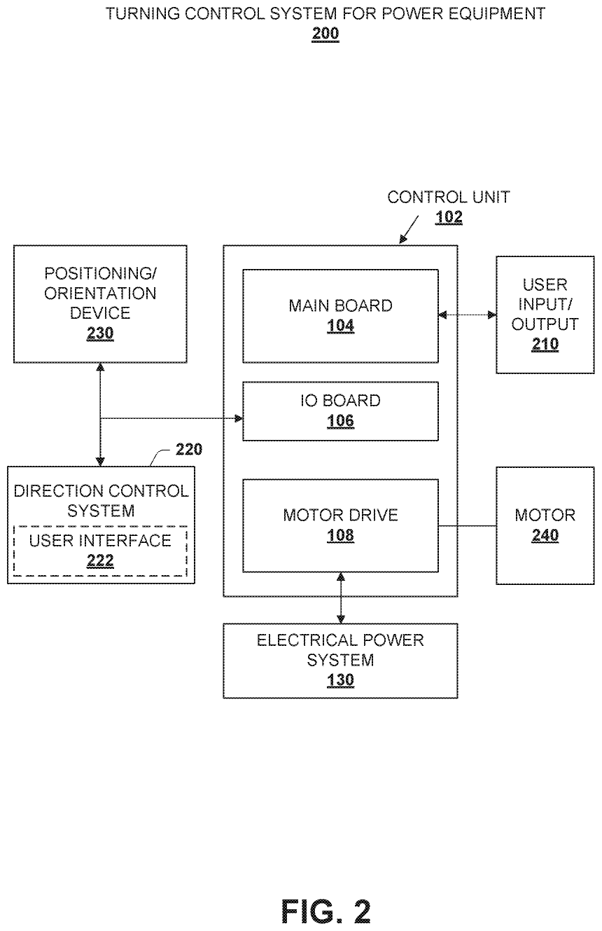

FIG. 1 illustrates a block diagram of an example control module architecture 100 for a power equipment device, according to some embodiments of the present disclosure. Control module architecture 100 can generate localized orientation data for the power equipment device and control a steering apparatus for the power equipment device based on one or more conditions pertaining to changes in the localized orientation data. Control of the steering apparatus of the power equipment device can facilitate changing direction of motion of the power equipment device and can be implemented in response to an operator command (e.g., see FIG. 2, infra). Orientation of the power equipment device can be determined and monitored in conjunction with the changing direction of motion as described throughout this specification.

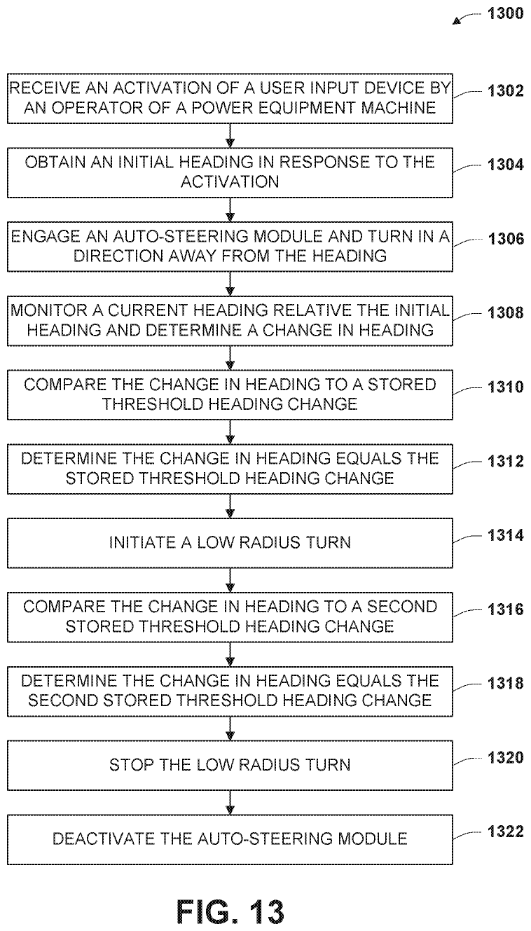

Control module architecture 100 can comprise a control unit 102, including a main board 104 and input/output (I/O) board 106. Main board 104 can comprise a suitable computing device, processing device, or the like (e.g., see computer 1302 of FIG. 13, infra). Main board 104 can also comprise one or more communication bus devices to communicatively couple main board 104 with I/O board 106, with a motor drive 108, as well as external devices such as direction control system 110.

Motor drive 108 can be powered by an electrical power system 130. Electrical power system 130 can comprise a battery, an alternator, a generator, or the like, or a suitable combination thereof. Utilizing electrical power from electrical power system 130, motor drive 108 can activate a prime mover 120 in some disclosed embodiments. Where prime mover 120 is a combustion engine, motor drive 108 can be configured to provide starting power to start prime mover 120. Where prime mover 120 is an electric motor, motor drive 108 can comprise a power transformer, heat sink or the like to deliver suitable electrical power to prime mover 120. Where prime mover 120 is a hydraulic or pneumatic motor, motor drive 108 can likewise be configured to generate suitable electrical power to control operation of prime mover 120 in response to an operator power control input (e.g., an accelerator, or the like).

Control module architecture 100 can include an orientation determination system 115 configured to generate an orientation and orientation change data. Likewise, a direction control system 110 can facilitate control over steering functions of a power equipment device and can be actuated by control unit 102 in conjunction with orientation determination system 115. For instance, main board 104 can utilize the orientation and orientation change data in conjunction with decision-making to utilize direction control system 110 to actuate steering equipment in conjunction with changing a direction of motion of the power equipment device.

In an embodiment, the direction change data generated at orientation determination system 115 can reflect an angular difference between a current direction of motion of the power equipment device, relative to an initial (or previous) direction or relative a threshold target direction stored by control unit 102. In another embodiment, the direction change data can reflect an angular displacement between an initial orientation of the power equipment device and a subsequent orientation(s) following movement of the power equipment device. In yet another embodiment, the direction change data can include a calculated or inferred displacement from a position correlated with the initial orientation and another position correlated with the subsequent orientation. The displacement can be determined at least in part from a function defining a steering path (e.g., an arc, a radius of curvature, or the like), data pertaining to the power equipment device (e.g., tire thickness, track width, and the like) and the change in orientation associated with the motion of the power equipment device, as one example (see also below). In further embodiments, direction change data can reflect an angular difference between a current (or subsequent) orientation and a previous (or initial) orientation in combination with a calculated displacement between the initial orientation position and the subsequent orientation position of the power equipment device.

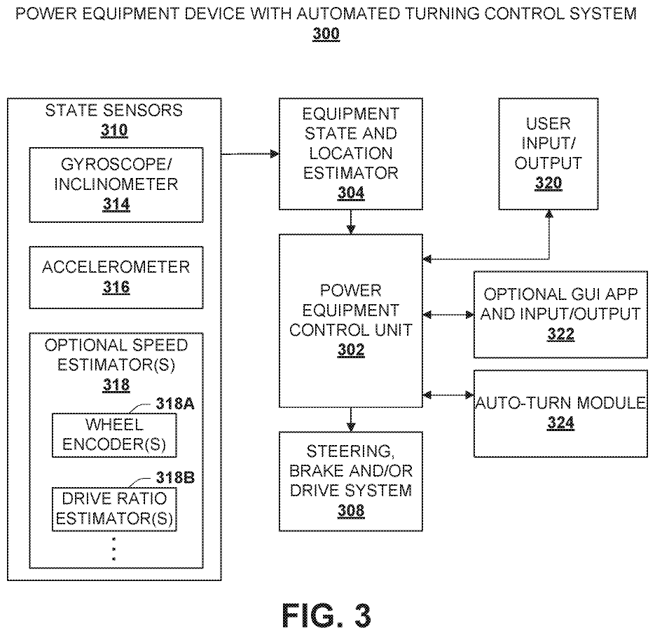

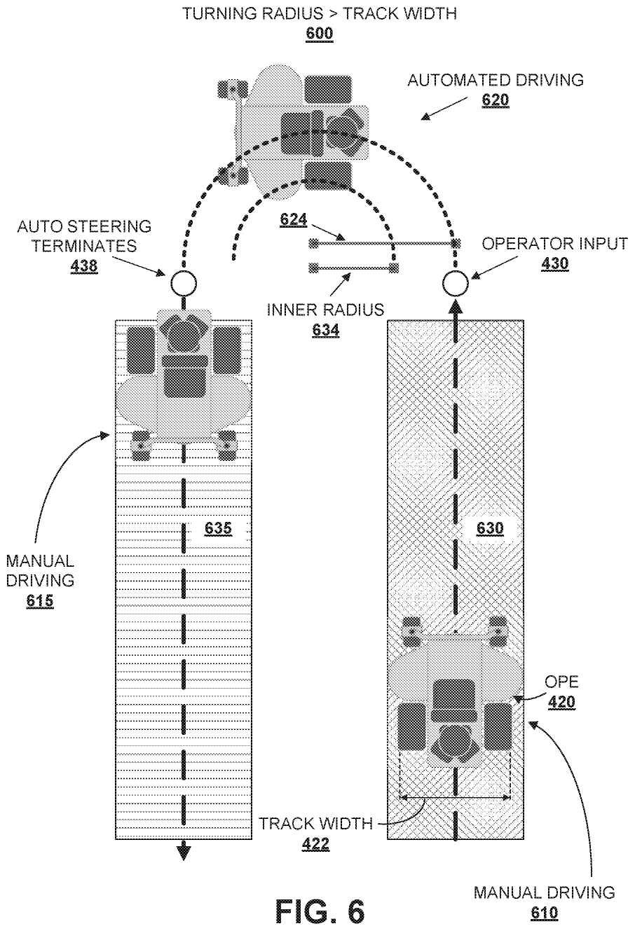

Orientation positioning equipment utilized by orientation determination system 115 can be embodied by a variety of suitable measuring and processing equipment according to embodiments of the present disclosure. Examples of orientation positioning equipment can include a gyroscope configured to detect change in heading of a power equipment device. As utilized herein, heading can be defined according to a fixed axis or geometry of the power equipment device, such as a forward drive direction associated with zero steering actuation, or other suitable orientation or geometry (e.g., a reverse drive direction, etc.). Other examples of orientation positioning equipment can include an accelerometer configured to detect acceleration of the power equipment device in one or more orthogonal axis. By monitoring changes in acceleration over short time intervals, direction control system 110 (or control unit 102) can be configured to calculate (and track) instantaneous velocity values for the power equipment device. This measurement can be useful during an automated turn as described herein for determining displacement in a direction orthogonal to an initial direction of motion (correlated in time with an operator input at an input/output device; see FIGS. 2 and 3, infra). Initial velocity in the orthogonal direction is zero before the turn starts, and changes in acceleration (determined from the accelerometer) can be utilized to calculate instantaneous velocity in the direction of the turn. Successive instantaneous velocity calculations at successive time internals can be utilized to infer an average velocity and estimate displacement over time. Further examples of orientation positioning equipment can include a wheel encoder (or multiple wheel encoders) to measure wheel rotation and calculate velocity and therefore displacement over time by an alternate mechanism. Direction control system 110 can utilize one or more of the foregoing example orientation equipment, or the like, or a suitable combination of the foregoing to measure changes in heading, determine velocity, estimate change(s) in position in one or more directions, and so forth, to facilitate automated turning of a power equipment device from a first path to a second path (e.g., see FIGS. 6-10, infra) in various disclosed embodiments.

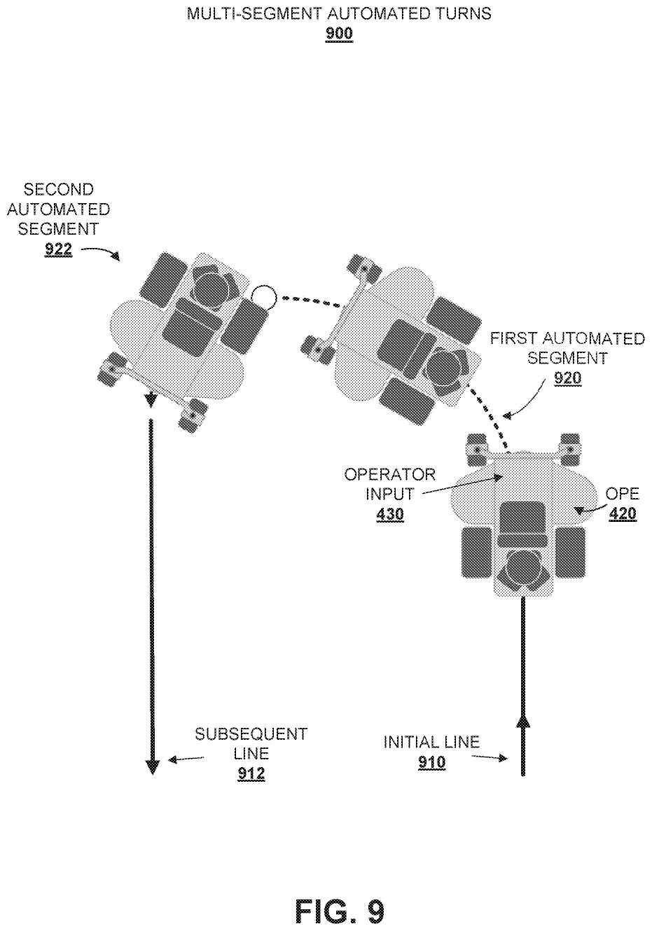

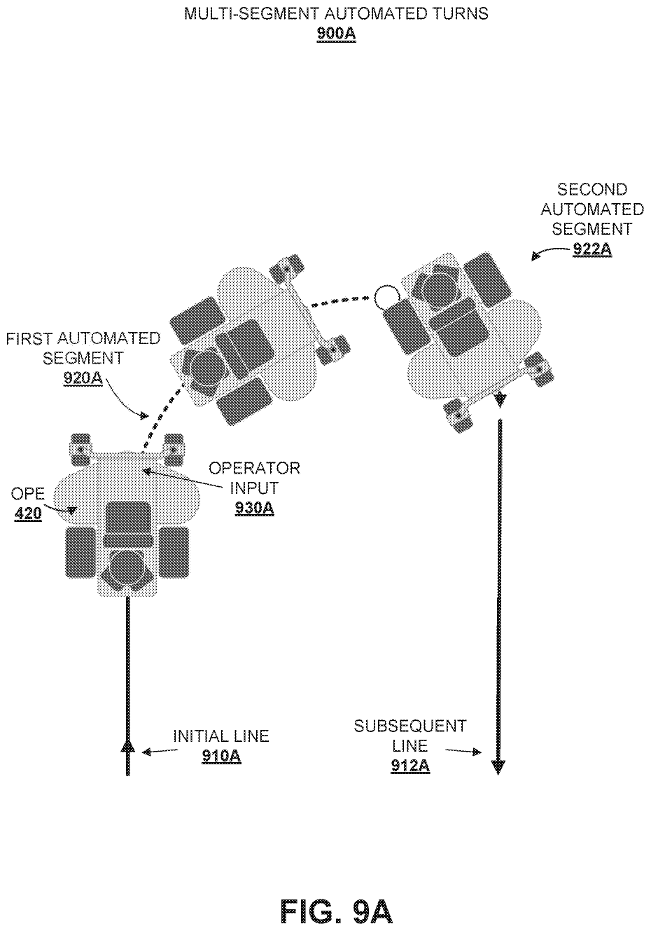

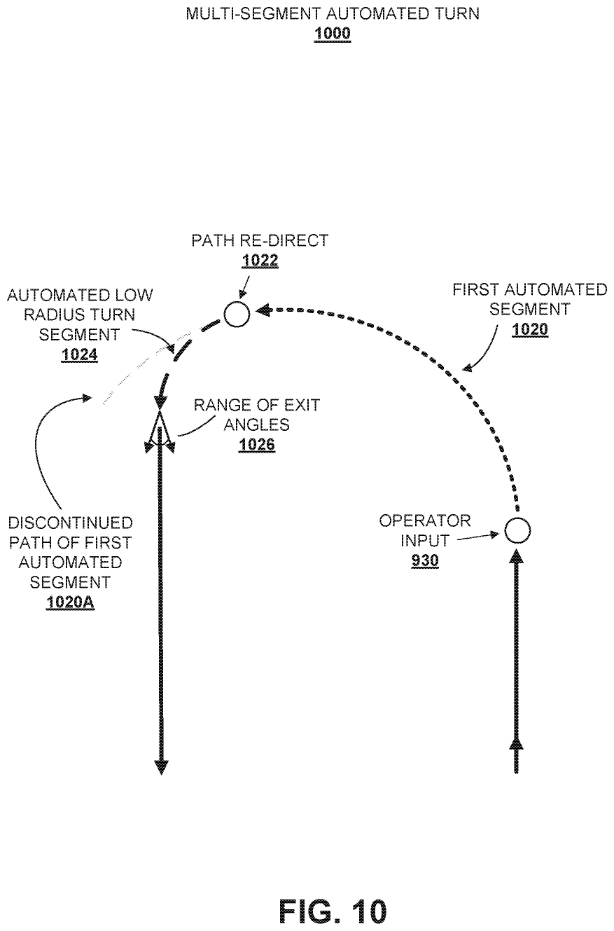

In an embodiment, control unit 102 can calculate a target steering angle for a power equipment device and utilize direction control system 110 to achieve the target steering angle in conjunction with implementing an automated turn for the power equipment device from a first orientation to a second orientation. In some embodiments the target steering angle can be a constant angle throughout a turn between the first orientation and the second orientation. In other embodiments, the target steering angle can be a first angle for a first portion of the turn and a second angle for a second portion of the turn. In still other embodiments, the target steering angle can be a varying angle that changes over time (or position) throughout the turn according to a pathing function. For example, the target steering angle can be calculated from a path defined by a function connecting a position associated with the initial orientation and a second position associated with a target orientation (or stored threshold orientation(s)), in still further embodiments. As an example, the function can be a smooth and continuous pathing function (e.g., see FIGS. 6-8, infra). In still further embodiments, the steering angle can be determined from one of a plurality of pathing functions and associated threshold orientations that in the aggregate provide a continuous (but non-smooth) path between the position and the second position (e.g., see FIGS. 9 and 10, infra).

In various embodiments, orientation data generated by orientation determination system 115 can be provided to mainboard 104 by way of I/O board 106, and mainboard 104 can be configured to calculate relative orientation, relative displacement or a combination thereof from an initial position while traversing a change in orientation. The calculated relative displacement and change in orientation can be compared to a threshold orientation(s) or threshold position displacement. Mainboard 104 can determine a target steering angle to maintain a calculated path at least in part from the relative displacement and change in orientation. Motor drive 108 can activate a steering apparatus of direction control system 110 to change the steering control of the power equipment device to achieve the target steering angle. The angular rotation metric can be measured in any suitable parameter that relates to or can translate to a controlled mechanical change in steering that causes a change to a direction of motion of the power equipment device. In an embodiment, the angular rotation metric can be embodied by a rotational angle of steering wheel(s) of the power equipment device. In other embodiments, the angular rotation metric can be embodied by a change in position of a steering gear that controls the rotational angle of the steering wheel(s) of the power equipment device. Where steering wheels are freely rotating about a center axis of the wheel(s) (and thus are not actively driven), the angular rotation metric will include only the rotational angle(s) of one or more wheels, and not a drive speed for steering wheels.

A speed with which motor drive 108 converts a calculated steering angle from mainboard 104 to a suitable steering control of a steering apparatus (e.g., see FIG. 3) can impact a quality of the control module architecture 100 for the power equipment device. For instance, the speed of changes to the motor drive 108 can affect perceived smoothness of the automated steering provided by control unit 102, and accordingly the perceived comfort of user-assisted automated steering provided by embodiments of the present disclosure. In various embodiments, a frequency of conversion of angular rotation data to motor output at prime mover 120 can be greater than 10 hertz (Hz); greater than 100 Hz; between about 100 Hz and about 10,000 Hz; between about 200 Hz and about 2,000 Hz; between about 500 Hz and about 1,500 Hz; between about 900 Hz and about 1100 Hz; or about 1,000 Hz in various embodiments.

Turning now to FIG. 2, there is depicted a block diagram of an example turn control system 200 for a power equipment device according to further embodiments of the present disclosure. Turn control system 200 can include control unit 102 as described above with respect to FIG. 1 (although turn control system 200 is not limited to the embodiments described above), including mainboard 104, I/O board 106 and motor drive 108. Further, an electrical power system 130 is provided that generates electrical power for powering motor drive 108, and a motor 240 for control of a mechanical steering apparatus (see, e.g., FIG. 3, infra) in response to control of motor drive 108, in some disclosed embodiments. In other disclosed embodiments, control unit 102 can instead be configured to control relative power output of a plurality of drive wheel motors to effect steering of a power equipment device. The latter can be utilized with individually powered hydraulic/electric/pneumatic drive wheels that are driven at different speeds to accomplish turning the power equipment device, rather than with a mechanical or electro-mechanical steering axis operated in conjunction with uniformly powered drive wheels.

A user input/output 210 is also provided, which can include user command or data entry to mainboard 104 (e.g., enabling an operator to turn control unit 102 on or off, providing an activation input(s) for turn control system 200, providing a turn direction input for turn control system 200, and so forth). User input/output 210 can include user-operated controls for a power equipment device in at least some embodiments (e.g., a manual acceleration pedal, a manual steering apparatus, a power take-off (PTO) activation/deactivation, and so forth).

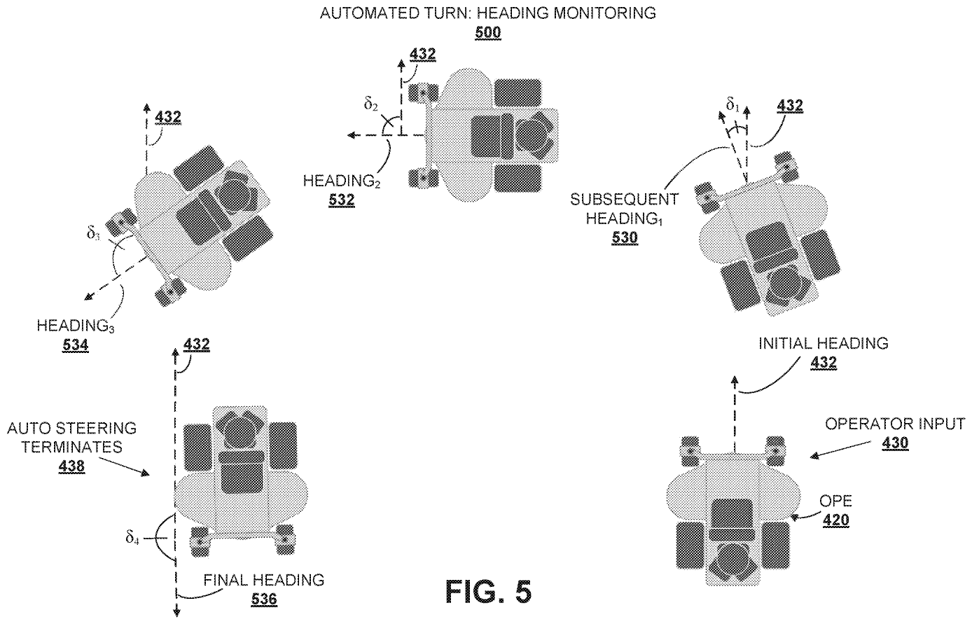

Communicatively connected to control unit 102 is a direction control system 220 and a positioning/orientation device 230. Positioning/orientation device 230 can include orientation positioning equipment described above with respect to orientation determination system 115. In addition, positioning/orientation device 230 can include electronic or processing devices to acquire measurement results from the orientation positioning equipment and determine a current orientation, a current relative orientation, an instantaneous velocity, a current relative position or the like of an associated power equipment device over time. Positioning/orientation device 230 can determine an initial heading for a power equipment device in response to activation of an autonomous turn at direction control system 220. Further, positioning/orientation device 230 can determine and track changes in heading of the power equipment device relative to the initial heading (e.g., see FIG. 5, infra) in conjunction with control unit 102 autonomously turning the power equipment device. In some embodiments, a user interface 222 of direction control system 220 can generate an audio/visual feedback corresponding to initiation, progress and completion of an autonomous turn. The audio/visual feedback can include a graphical display of relative orientation of the power equipment device, or a relative position along a turn path calculated by positioning/orientation device 230, or other suitable audio/visual output. An operator selected turn direction entered into user input/output 210 can also be displayed, indicated, announced or otherwise output at user interface 222 in some embodiments.

In various embodiments, user interface 222 can optionally facilitate input of operator settings, operator-selectable parameter values, command entry, data entry, or the like, and for output of data to a user, such as acknowledgment(s) of a user input(s), display of operation mode(s), display of input parameter values, display of a command(s) being actively processed or list of commands previously processed, and so forth. In some embodiments, user input/output 210 can be utilized for user input and output functions of direction control system 220, instead of a user interface 222 particular to direction control system 220. In other embodiments, user input/output 210 can incorporate a user interface for control unit 102 in combination with a user interface for direction control system 220.

In various embodiments, a target path of motion for a power equipment device can be established by direction control system 220. At a high level, the target path of motion can embody a turn from a first heading to a second heading. In some embodiments, the turn can be a simple continuous and smooth function such as a single radius (e.g., circular) turn. In other embodiments, the turn can be another continuous and smooth function such as a non-single radius curve, including a variable radius curve, a multi-radius curve, a curve(s) defined by a polynomial function, or the like. In still other embodiments, the turn can be defined by multiple continuous and smooth functions joined together to form a continuous non-smooth function. As a specific non-limiting example, a first portion of a turn can be defined by a first smooth and continuous function (e.g., a circle, an arc, a parabola, etc.) and a second portion of the turn can be defined by a low radius turn—including a zero radius turn (e.g., spinning in place)—defining a continuous, but not smooth turn (e.g., see FIGS. 9 and 9A, infra). Other examples of single or multi-function turns are within the scope of the present disclosure as well.

To illustrate, an operator input at user input/output 210 (or user interface 222) can serve as a command to start an autonomous turn. The operator input can also include a direction in which the turn is to be implemented. The operator input can be a single input starting the turn and a second input providing the direction, or can be a single input both starting the turn and providing the direction. Suitable operator inputs can include, for instance: a button press, a release of a button press, activation of a switch, turn of a dial, a verbal instruction, a display screen menu selection, and so forth, or suitable combinations of the foregoing. Direction control system 220 can acquire an initial heading of a power equipment device from positioning/orientation device 230 contemporaneous with the operator input (or the operator input starting the turn, where separate inputs are involved).

In response to the operator input, control unit 102 can begin automated control over a steering apparatus of an associated power equipment device. Direction control system 220 can generate a steering control signal utilized by control unit 102 for controlling the steering apparatus. The steering control signal is determined by direction control system 220 according to a predetermined turn path configured to move the power equipment device from a first heading to a second heading defined by the turn, and optionally from an initial position to a subsequent displaced position defined by the turn. The predetermined turn path can be defined by a function(s) stored at direction control system 220.

The steering control signal generated by direction control system 220 is calibrated to align a steering apparatus of an associated power equipment device to a path on a surface matching the predetermined turn path. In various embodiments, the steering control signal is received by motor drive 108 or motor 240 and utilized to autonomously modify a steering apparatus of the power equipment device to achieve a steering direction calibrated to move the power equipment device along the predetermined turn path.

In some embodiments, magnitude of the steering control signal can be calibrated to discrete steering apparatus angles. Direction control system 220 can be configured to generate steering control signal magnitudes that align the steering apparatus of the power equipment device along curvature of the path and according to relative position of the power equipment device along the path. As an example, the steering control signal can be a constant magnitude steering control signal for a path defined by a constant radius turn, such as a circle or segment of a circle in some disclosed embodiments (e.g., see FIGS. 6 through 8, infra). In other embodiments, the steering control signal can have multiple steering control signal magnitudes for a turn defined by multiple respective constant radius turn segments. In other embodiments, the steering control signal can have a magnitude that varies as a disclosed power equipment device traverses a path defined by a function of varying radius of curvature. In the latter case, direction control system 220 can sample heading, acceleration or velocity measurements from positioning/orientation device 230 and generate an estimate of velocity and position of a power equipment device along such a path. Estimates of velocity and position can be updated periodically. As the heading, velocity or position of the power equipment changes, direction control system 200 can determine suitable changes to the steering control signal magnitude as the power equipment device executes the turn defined by the variable radius function. In still further embodiments, where one or more constant radius turns are implemented instead, direction control system 220 can instead sample heading data from positioning/orientation device 230 and maintain a first steering control signal magnitude correlated with a first steering angle for a first range of headings from an initial heading, and optionally switch to a second steering angle (and second steering control signal magnitude) for a second range of headings from the initial heading (and optionally a third steering angle for a third range of headings, and so on).

As stated previously, direction control system 220 terminates the steering control signal upon determining the power equipment device has completed the predetermined turn path. Termination of the steering control signal causes motor drive 108 and motor 240 to stop autonomous control over the steering apparatus of the power equipment device, restoring exclusive control over the steering apparatus to an operator of a power equipment device. Accordingly, upon completing the turn path autonomous steering ends and an operator then reasserts manual operator-guided steering. In some embodiments, turning control system 200 can monitor the steering apparatus (or user input/output 210, user interface 222 or other suitable operator activity) and terminate the autonomous steering by motor 240 and motor drive 108 in response to detecting a qualifying condition affecting the steering apparatus, in response to a user input, or the like (e.g., see FIG. 3, infra). As one non-limiting example, detecting an operator's manual manipulation of the steering apparatus can cause direction control system 220 to terminate the steering control signal and end the autonomous control of the steering apparatus. More generally, detection of operator manual manipulation of the steering apparatus causes turn control system 220 to end autonomous steering (even prior to completion of the turn path) and restores control of the steering apparatus to the operator.

Referring now to FIG. 3, there is depicted a block diagram of an example power equipment device 300 with an automated turning control system, according to alternative or additional embodiments of the present disclosure. Power equipment device 300 can comprise a power equipment control unit 302, communicatively and mechanically coupled with steering, brake or drive systems 308 of the power equipment device 300. An equipment state and location estimator 304 can provide heading or acceleration measurements (and optionally velocity measurements) to power equipment control unit 302 in conjunction with limited steering automation of power equipment device 300, according to various disclosed embodiments. In some embodiments, equipment state and location estimator 304 can provide information usable by power equipment control unit 302 to drive and stop power equipment device 300, in addition to limited autonomous steering of power equipment device 300. In general, power equipment device 300 is not an autonomous device. However, the automated turning control system can provide power equipment device 300 with limited autonomous steering, drive or brake functionality to automatically turn power equipment device from a first heading to a second heading, rather than operate as a fully autonomous device. Moreover, power equipment device 300 and its automated turning control system can be independent of a wireless communication system that provides global or local positioning data for power equipment device 300. For instance, the automated turn control system can be devoid of a global positioning system (GPS), a wireless triangulation positioning system, a real-time kinematic (RTK) enhanced positioning system, or the like. Though offering only limited autonomous control, power equipment device 300 can be significantly less complex and more cost efficient while still offering limited automation, achieving a synergy in cost effectiveness and operator functionality.

Power equipment control unit 302 can be configured differently for different power equipment devices 300. For instance, for a power equipment device with an independent drive apparatus and steering apparatus, power equipment control unit 302 can be configured to control a steering apparatus of steering, brake or drive system 308, but not the brake apparatus or drive apparatus. In this embodiment, power equipment control unit 302 can autonomously control the steering apparatus while an operator controls a drive apparatus, a braking apparatus or both. In an alternative embodiment, power equipment control unit 302 can be configured to jointly control the steering apparatus and a drive system, while the operator retains manual control over the braking apparatus. In embodiments where steering is accomplished through the drive system (e.g., independently driven drive wheels that are driven at differing speed to accomplish turning), power equipment control unit 302 can have control over steering and drive functionality through control of independent drive apparatuses (e.g., a left wheel drive apparatus and a right wheel drive apparatus). In at least some of the latter embodiments, where braking is accomplished by reducing or stopping power to the drive apparatus, power equipment control unit 302 can effectively have control over steering, braking and drive functionality as all three are embodied in the independent drive apparatuses.

Where a steering apparatus is at least in part dependent upon a drive system of power equipment device 300, a steering control module of steering, brake or drive system 308 can effectively give power equipment control unit 302 control over speed of power equipment device 300 in addition to steering. This enables embodiments in which power equipment control unit 302 can be configured to change speed of power equipment device 300 during an automated turn. As an example, power equipment control unit 302 can be configured to change speed of power equipment control unit 302 to a turning speed in response to receiving a turn command (e.g., at user input/output 320; see below). The turning speed can be a fixed turning speed in an embodiment (e.g., selected from 3 to 15 miles per hour (mph), or any suitable value or range there between; such as 4 mph, 4.5 mph, 5 mph, 6 mph, 8 mph, 10 mph, 12 mph, 15 mph, etc.), or the turning speed can be a proportion of an initial speed in other embodiments (e.g., ⅔ the initial turning speed; ½ the initial turning speed, or a like proportion). In the latter embodiments, the initial speed can be defined by power equipment control unit 302 as a current speed of power equipment device 300 concurrent with receipt of an operator turn command (e.g., provided at user input/output 320 or optional GUI app 322). In response to the operator turn command and determination of the initial speed, power equipment control unit 302 can be configured to operate steering, brake or drive system 308 to achieve the turning speed from the initial speed.

It should be understood that user input/output 320 may comprise any of a variety of common operator controls such as and without limitation, a lap bar moveable between a plurality of user selectable positions, accelerator pedals moveable between a plurality of user selectable positions, a steering wheel moveable between a plurality of angular positions about a steering wheel operational axis, user positionable push buttons, user positionable switches, or other operator controls as chosen with good engineering judgment. It should further be understood that the positions of the latter operator controls and the state of user input/output 320 generally may be represented by power equipment device 300 data that may be collected, stored, or recorded as part of the present subject matter and which may be used in a recorded turn profile as addressed below.

As a non-limiting illustrative example, the steering apparatus can be at least in part dependent upon the drive system in the case of independent drive apparatuses powering respective drive wheels of power equipment device 300, where steering is accomplished by changing relative speed of a first drive wheel (e.g., a left drive wheel) versus a second drive wheel (e.g., a right drive wheel). For instance, a first independent drive can provide mechanical power to a first drive wheel, and a second independent drive can provide second mechanical power to a second drive wheel. Power equipment control unit 302 can operate the first independent drive at a first mechanical power magnitude to operate the first drive wheel at a first rotational speed, and can operate the second independent drive at a second mechanical power magnitude to operate the second drive wheel at a second rotational speed. This effectively turns power equipment device 300 in a direction away from the drive wheel rotating at higher rotational speed. Power equipment control unit 302 can also change turning speed by changing the first rotational speed and second rotational speed in suitable proportion during the turn: either at an increased proportional speed to increase speed during the turn, or a decreased proportional speed to decrease speed during the turn. In these embodiments, turning speed can be fixed throughout a duration of a turn, can change for different segments of a turn, can vary according to varying turning radius (in multi-radius or variable radius of curvature turns), or the like, or a suitable combination of the foregoing.

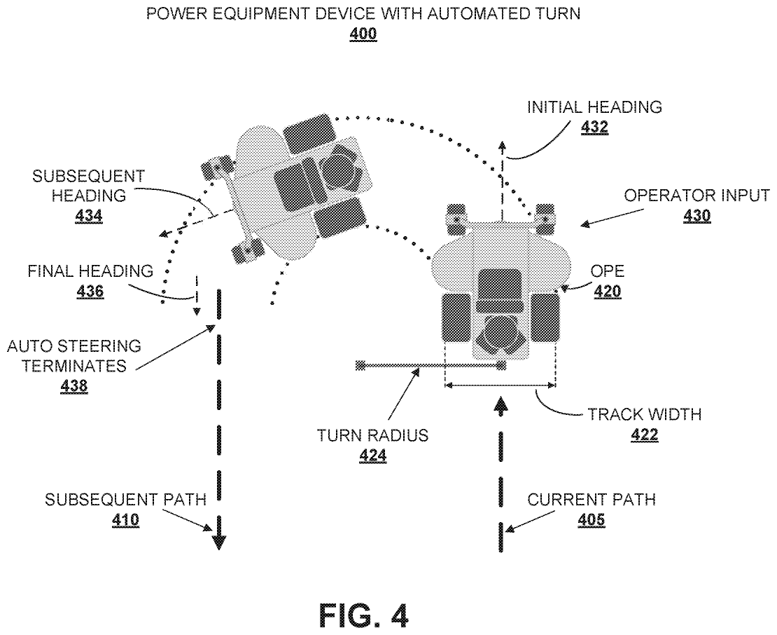

Equipment state and location estimator 304 can provide relative orientation data for power equipment device 300, or both relative orientation and relative displacement data for power equipment device 300, utilizing one or more state sensors 310. Further to the above regarding power equipment device 300 data, generally, the state sensors 310 may comprise one or more IMU or other sensors that may measure data or provide data sufficient to calculate acceleration, position of or rate of rotation of the power equipment device 300 about one or more axes in three dimensional space (e.g., yaw/pitch/roll), orientation of the power equipment device 300 with respect to a magnetic direction or compass direction. Similarly, state sensors 310 may include sensors directed to measuring data or providing data sufficient to calculate or estimate rear wheel speed like rear wheel encoders 318A. It should be understood that rear wheel encoders 318A is one non-limiting example of a sensor directed to measuring data or providing data sufficient to calculate or estimate rear wheel speed and that other sensors may be used to measure similar or related data such as to measure encoder tick rate, or measure output from an operationally connected electric motor or to measure proximity, position or speed with a Hall effect sensor. It should be understood that the data measured or provided by the sensors 310 may be collected, stored, or recorded as part of the present subject matter and which may be used in a recorded turn profile as addressed below. In one embodiment, equipment state and location estimator 304 can utilize a gyroscope/inclinometer 314 to generate relative heading measurements (e.g., a yaw measurement) over time and also calculate change(s) in heading over time (e.g., see FIGS. 4 and 5, infra). Equipment state and location estimator 304 can utilize the heading measurements and establish an initial heading correlated with a point in time (e.g., in response to an input at user input/output 320, such as an auto-turn command, an auto-turn direction command, or the like; see FIG. 4). Subsequent heading measurements can be utilized to determine an angular displacement of power equipment device 300 from the initial heading (e.g., as shown in FIG. 5). In further embodiments, equipment state and location estimator 304 can utilize an accelerometer 316 to measure acceleration for the power equipment device 300 in one or more orthogonal axis. Subsequent instances of acceleration at subsequent times can be utilized by equipment state and location estimator 304 to calculate instantaneous velocity of the power equipment device 300 along the one or more axis of rotation and estimate an average velocity for discrete periods of time. The average velocity can likewise be utilized to estimate displacement of power equipment device 300 from an initial position. In various embodiments, the initial position can be defined at the point in time (e.g., an initial x₀ and initial y₀ position defined coincident with an input at user input/output 320) and subsequent displacement estimations can be relative to the initial position.

In one or more embodiments of the present disclosure, state sensors 310 can include one or more optional speed estimators 318. For example, a wheel encoder module(s) 318A is an example of a suitable speed estimator 318. Wheel encoder module(s) 318A can be configured to measure angular rotation of one or more wheels of power equipment device 300. Equipment state and location estimator 304 can then determine velocity of power equipment device 300 from a (stored) circumference of an associated wheel(s)/tire(s), and a number of angular rotations per amount of time. In further embodiments, state sensors 310 can optionally include a drive ratio estimator(s) 318B configured to infer speed of one or more drive wheels based on power output of a drive motor(s) coupled to the one or more wheels. Such determined velocity or inferred speed can likewise be utilized by equipment state and location estimator 304 for determining (or supplementing) relative position location of power equipment device 300 from the initial position, in such embodiments. Other speed estimators known in the art to be usable with a power equipment device, or reasonably conveyed to one of ordinary skill in the art by way of the context provided herein are within the scope of the present disclosure.

Power equipment control unit 302 can further contain or be communicatively connected to an auto-turn module 324. Auto-turn module 324 can be substantially similar to direction control system 220 in one or more embodiments of the present disclosure. However, the disclosure is not limited to these embodiments, as auto-turn module 324 can have some but not all of the elements or configurations of direction control system 220 described above, and can have additional elements or configurations not disclosed for direction control system 220 in still other embodiments.

Further to the above regarding power equipment device 300 data, in some embodiments, any data measured or provided by the sensors 310 may be collected, stored, or recorded and used in a recorded turn profile usable by the auto-turn module 324. In addition to the data already noted above, data measured or provided by the sensors 310 that may be collected, stored, or recorded and used in a recorded turn profile may comprise commanded drive signals or related data from user input/output 320, steerable wheel angle indicators, power consumption of one or more electric motors (e.g., motor drive 108), and differential drive speed of drive wheels. Other data that may be collected, stored, or recorded and used in a recorded turn profile includes data about the geometry of the power equipment device 300 such as rear wheel track width 422, front wheel track width, wheel base, rear wheel/tire diameter, front wheel/tire diameter, top ground speed, minimum turning radius, rear tire width, and front tire width. Other data that may be collected, stored, or recorded and used in a recorded turn profile includes data calculated from or derived from other collected, stored, or recorded data such as, but not limited to, rate of rotation of one or more wheels or motors, turning radius, ground speed, relative drive strength, and angle differentials.

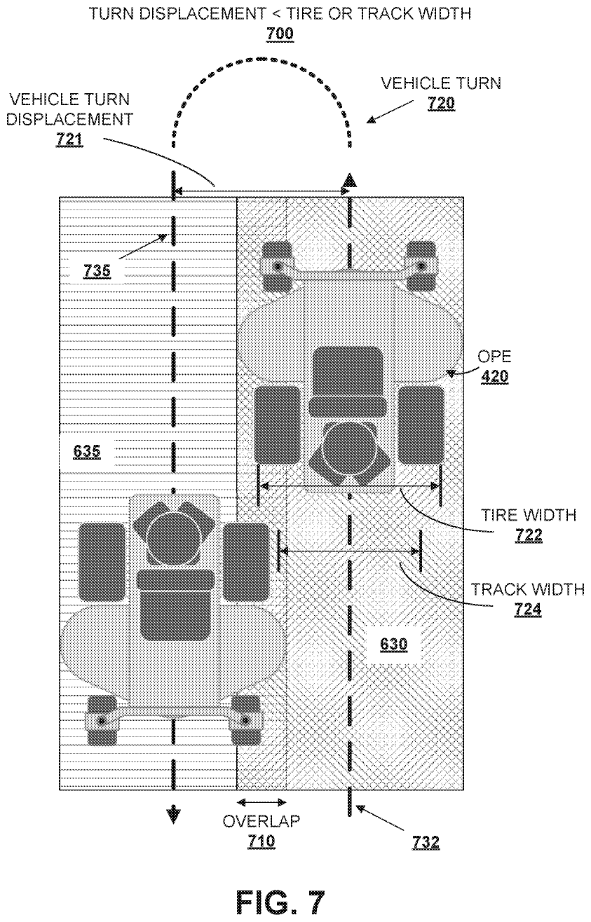

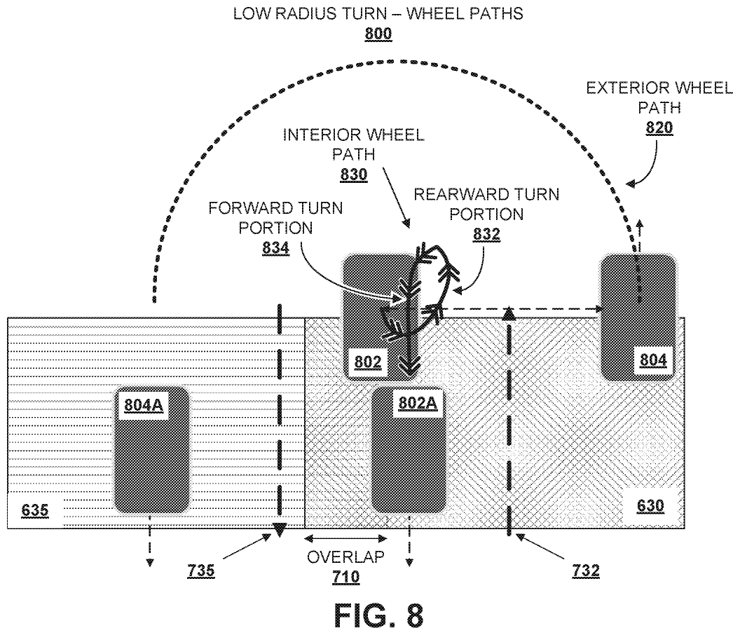

Auto-turn module 324 can store one or more functions to define a curve configured to turn power equipment device 300 from a first heading to a second heading. The function(s) can be a smooth and continuous function, a plurality of smooth and continuous functions, a plurality of smooth and continuous functions coupled together at a point to define a continuous non-smooth curve/path, or other non-smooth functions in at least some disclosed embodiments. In one example, the curve can be defined by a constant radius function with a radius different from a track width of the power equipment device 300 (e.g., see FIGS. 7 and 8 infra). In some embodiments the radius can be larger than the track width of power equipment device 300, and in other embodiments the radius can be smaller than the track width of power equipment device 300. In the latter embodiments, power equipment device 300 is a zero turn radius apparatus having the mechanical capacity to implement a turn with a radius smaller than the track width, and as small as a zero radius turn in at least one embodiment. In another example, the curve can be defined by a varying radius function or a multi-radius function such as a parabola or other non-circular smooth and continuous function. In another embodiment, auto-turn module 324 can store a plurality of functions that, when combined together in sequence, define the curve. A first function can be a first constant radius turn and a second function can be a second constant radius turn, smaller than the first constant radius turn.

A curve defined by auto-turn module 324 can be translated to a steering angle of steering, brake or drive system 308 by power equipment control unit 302. Where the curve defines a constant radius, the steering angle can be constant for at least a portion of the curve defined by an initial heading and a first threshold heading. In this case, state sensors 310 can, optionally, be limited to a gyroscope/inclinometer 314 to determine the initial heading: h; and monitor a current heading: h_{c} relative to the initial heading. Power equipment control unit 302 can compare the current heading to the initial heading until a difference reaches the first threshold heading: hᵢ−h_{c}=hₜₕ₁. Where the curve defines a variable radius or multi-radius turn, state sensors 310 can include accelerometer 316 or optional speed estimator(s) 318 to estimate position of power equipment device 300 along the curve, and power equipment control unit 302 can be configured to periodically update the steering angle to progress power equipment device 300 along the curve until a final heading (e.g., 180 degree change in heading or other suitable value) is reached.

Power equipment control unit 302 can optionally include a graphical user interface (GUI) app and input/output 322. GUI and input/output 322 can include a display screen for user input and output in various embodiments. An input to optional GUI app and input/output 322 from an operator of power equipment device 300 can initiate an automated turn described herein and provide a direction for the turn. In response to the initiation and direction, power equipment control unit 302 can generate an initial heading, obtain a path for the automated turn or instructions for accomplishing the turn from auto-turn module 324, and activate steering, brake or drive system 308 to turn the power equipment device along the path (or consistent with the instructions). Position of the power equipment device along the turn can be estimated and displayed or indicated at optional GUI app and input/output 322 in some embodiments, along with a direction of the turn. A second input to GUI app and input/output 322 can terminate the automated turn, in some embodiments, ending power equipment control unit 302 controlling steering, brake or drive system 308. Ending control of steering, brake or drive system 308 by power equipment control unit 302 can return exclusive control over a steering apparatus to an operator of the power equipment device, in one or more embodiments. In at least some embodiments, manual manipulation of the steering, brake or drive system 308 can also terminate the automated turn and end power equipment control unit 302 controlling steering, brake or drive system 308 (restoring exclusive control to the operator).

Referring now to FIG. 4, there is shown an example outdoor power equipment device (OPE) 420 executing an automated turn 400 according to various embodiments of the present disclosure. In some embodiments, automated turn 400 can be a constant radius turn, but is not limited to this embodiment. As shown, OPE 420 is moving along a current path 405 defined by a vector associated therewith. An operator input 430 is provided and in response thereto, a power equipment control unit (not depicted, but see power equipment control unit 302 of FIG. 3, supra) is activated and obtains a measurement of an initial heading 432 associated with current path 405 in response to operator input 430. The power equipment control unit can associate the measurement of initial heading 432 with an initial position of OPE 420 in some embodiments, though for a constant radius automated turn 400 as shown in FIG. 4, position determination can be optional.

Upon measuring initial heading 432, the power equipment control unit can turn OPE 420 in a direction indicated by operator input 430. In the drawing shown in FIG. 4, a left direction turn is implemented, through in other embodiments a right turn can be implemented in an analogous fashion.

A turning signal utilized to implement automated turn 400 can be determined from one or more stored parameters. For example, a stored parameter defining a turn radius 424 can be utilized for determining the turning signal. As other examples, a stored parameter defining a track width 422 (which refers to a width of drive wheels as utilized herein) or optionally a width of a powered implement (e.g., a mow deck width) can also be utilized for determining the turning signal. The turning signal is calculated to achieve the stored turn radius 424 (optionally subject to track width, mow deck width or other stored parameter). A turning angle correlated to the turning signal and that achieves the turn radius 424 is implemented at a steering apparatus of OPE 420.

While turning, measurements of a subsequent heading 434 are taken for OPE 420. The subsequent heading 434 measurements can be compared with a heading threshold. The comparison can be done by comparing a current heading with respect to a stored value of final heading 436, or can be done by comparing the difference of the current heading and the initial heading to the stored value of final heading 436 (which can be the same where the initial heading is defined as 0, for instance). The stored value of final heading 436 can be any suitable metric of heading. For instance, measured in degrees the stored value can be a suitable heading between 0 and 360 degrees (e.g., about 180 degrees, about 90 degrees, about 200 degrees, and so forth), or any suitable value or range of values between 0 and 360 degrees (which value or range includes the precise value therein). In other embodiments, different units of heading can be employed, such as radians, or the like.

In the example illustrated by automated turn 400, prior to equaling the heading threshold, the power equipment control unit maintains the turning signal and the turn angle for OPE 420 at a constant value/angle. Upon reaching a final heading 436 that matches the heading threshold, auto steering terminates 438. This restores control over the steering apparatus to an operator of OPE 420 with OPE 420 aligned for travel along a subsequent path 410.

FIG. 5 illustrates a diagram of heading monitoring 500 for an automated turn according to one or more aspects of the disclosed embodiments. FIG. 5 depicts OPE 420 in a bottom right corner of the drawing. An operator input 430 is received which causes a power equipment control unit to determine an initial heading 432 for OPE 420 coincident with operator input 430. The initial heading 432 can be measured with a gyroscope, yaw meter, or the like.

During an automated turn, subsequent heading measurements of OPE 420 are captured by the power equipment control unit. A first subsequent heading 530 is measured which defines a first angular displacement δ₁ from initial heading 432 as shown. In various embodiments, δ₁ can be compared with a stored target/threshold angular displacement in conjunction with continuing the automated turn. In response to determining the angular displacement value meets or exceeds the stored angular displacement, the automated turn can end. For the example of FIG. 5, heading measurements continue with a second subsequent heading 532 and second angular displacement δ₂ from initial heading 432. As the automated turn continues, a third subsequent heading 534 is taken to determine a third angular displacement δ₃ from initial heading 432. A final subsequent heading 536 and fourth angular displacement δ₄ meets the final heading 536 (in this case, about 180 degrees) and auto steering terminates 438. In some embodiments, final heading 536 can be in a range of about 170 degrees to about 190 degrees from initial heading 432.

In further embodiments, an automated turn can change a steering angle of a power equipment device at different heading measurements. For instance, a first turn angle implemented by a power equipment control unit utilized following operator input 430 can be continued until a first threshold angular displacement from initial heading 432 is achieved. Upon reaching or exceeding the threshold angular displacement, a second turn angle can be implemented by the power equipment control unit. The second turn angle can be continued until a third threshold angular displacement is determined, and so on (see, e.g., FIGS. 9 and 9A).

FIG. 6 illustrates a drawing of an example turning radius 600 that is greater than a track width of an OPE 420, according to particular embodiments of the present disclosure. FIG. 6 shows OPE 420 being driven in a manual driving mode 610. An implement width of OPE 420 during manual driving mode 610 defines a first cutting swath 630 along a driving path of manual driving mode 610.

In response to receiving an operator input 430 an automated turn is initiated by a power equipment control unit of OPE 420 as described herein. The automated turn is represented by automated driving 620 as shown. The automated turn defines a turn radius 624. Where turn radius 624 is larger than a track width 422 of OPE 420, an inner turn radius 634 of an inner tire of OPE 420 is a positive number (e.g., greater than zero). The inner turn radius 634 is measured with respect to a drive wheel of OPE 420 that is closest to a center of the automated turn, or described differently, is on a side of OPE 420 into a direction of the automated turn. Thus, for the left-hand turn shown in FIG. 6, the left drive wheel of OPE 420 defines inner radius 634.

Where inner radius 634 is greater than zero, the inner tire will continue rotating throughout the automated turn. This mitigates or avoids turfing of ground beneath the inner tire during the automated turn. In contrast, significant turfing of the ground can occur during the automated turn where the inner radius is approximately zero, or, e.g., smaller than a width of a drive wheel of OPE 420, or smaller than half the width of the drive wheel, etc. In various disclosed embodiments, a disclosed power equipment control unit can be configured to implement an automated turn having a turn radius 624 that is greater than track width 422 as shown in FIG. 6, or less than track width 422 as shown in FIG. 7, infra.

Following completion of the automated turn as described herein, automated driving 620 ends as auto steering terminates 438. Manual driving 615 is restored in a second direction. The implement width defines a second cutting swath 635 while manually operated in manual driving mode 615. As shown, with turn radius 624 significantly larger than track width 422 (and wider than an implement width in the depicted embodiment(s)) the second cutting swath 635 does not overlap first cutting swath 630. A turn radius 624 can be selected to minimize or avoid ground turfing while using a turn radius that is approximately twice track width 422 (or implement width) of OPE 420.

FIG. 7 illustrates a drawing of an example turning radius 700 that is less than a tire width or a track width of an OPE 420, according to still further embodiments of the present disclosure. Turning radius 700 can be configured to mitigate or avoid turfing of ground during a turn, by maintaining motion of an inner drive wheel throughout the turn (e.g., see FIG. 8, infra). Turning radius 700 defines a tire width 722 as a distance between external surfaces of drive wheels/tires of OPE 420, and track width 724 is defined as a second distance between center thicknesses of the drive wheels/tires as shown. An implement width of OPE 420 defines a first cutting swath 630 defined by a cross-hatch area along an outbound path 732 and defines a second cutting swath 635 defined by a horizontal-shaded area along a return path 735. The first cutting swath 630 and second cutting swath 635 overlap in an overlap region 710. Overlap region 710 defines an area on a surface where the implement covers the same portion of the surface on outbound path 732 and return path 735. In addition, tire width 722 can overlap in part on outbound path 732 and return path 735.

In embodiments where vehicle turn 720 is a constant radius smaller than tire width 722 or track width 724, OPE 420 is a low radius turn or zero radius turn vehicle. This allows a vehicle turn displacement 721 to be smaller than tire width 722 (or track width 724) without turfing ground during vehicle turn 720. To avoid turfing the ground, vehicle turn causes an inside drive wheel to turn in a reverse direction for a portion of the turn as shown in FIG. 8, infra.

Turning now to FIG. 8, a low radius turn 800 is shown providing wheel paths for both exterior and interior wheels, labeled according to a direction of the low radius turn 800. Low radius turn 800 is shown implementing a left hand turn. For a right hand turn the exterior and interior wheels (as well as the respective turning paths) are reversed from that shown in FIG. 8. Thus, wheel 802 is defined as the interior wheel for the left-hand turn shown by low radius turn 800 and wheel 804 is defined as the exterior wheel. For a right-hand turn, wheel 802 becomes the exterior wheel and wheel 804 becomes the interior wheel.

As shown in FIG. 8, wheels 802 and 804 are moving toward the top of the page while traversing outbound path 732. Arrows at the top of interior wheel 802 and exterior wheel 804 show the initial direction of movement into low radius turn 800. As the turn initiates, exterior wheel 804 follows the path defined by exterior wheel path 820. Interior wheel follows the path defined by interior wheel path 830, including two segments. A rearward turn portion 832 followed by a forward turn portion 834. Note that rearward turn portion 832 and forward turn portion 834 track an example interior wheel path for a power equipment device having a low radius turn capability (e.g., turn radius smaller than a track width of drive wheels) or zero radius turn capability (e.g., the capacity to mechanically spin in place), or a suitable value there between (e.g., between zero radius of curvature and less than the track width of the drive wheels). Significantly, interior wheel path 830 maintains interior wheel 802 in rotation throughout low radius turn 800, mitigating or avoiding any turfing of ground caused by interior wheel 802 being dragged along the ground or pivoting in place without rotating. This achieves a high-quality appearance of ground after being traversed by the power equipment device, by avoiding uprooting vegetation such as grass during low radius turn 800.

Following completion of low radius turn 800, interior wheel 802A and exterior wheel 804A are shown traveling in a different direction. Specifically, return path 735 is approximately in a reverse direction with respect to outbound path 732 (e.g., 170 degrees to 190 degrees change in heading from outbound path 732, or other suitable range below or above 180 degrees). It should be appreciated that in other embodiments, low radius turn 800 can terminate in another direction, such as (about) forty degrees from outbound path 732, (about) eighty or ninety degrees from outbound path 732, (about) one hundred twenty degrees from outbound path 732, (about) two hundred fifty to three hundred degrees from outbound path 732, or more than a complete turn (e.g., more than three hundred sixty degrees), or any other suitable value or range of values. Thus, low radius turn 800 is not limited to a reverse direction as shown by return path 735, but can continue on to any suitable direction as would be understood in the art.

FIG. 9 illustrates a diagram of a multi-segment automated turn 900 according to still further embodiments of the present disclosure. Multi-segment automated turn 900 can be implemented from stored parameters defining an end of a turn, as well as discrete portions of the turn. The discrete portions can be defined based on parameter values associated with turning an OPE 420. These parameters can include measured heading values, measured or estimated displacement values, or a combination of the foregoing.

With respect to heading measurements, different metrics can be employed such as an orientation (e.g., a yaw measurement), a direction (e.g., 15 degrees west of magnetic north), a relative change in orientation (e.g., ten degrees from an initial heading, etc.), or the like, of OPE 420. Discrete ranges of heading parameter values can be utilized to define (in whole or in part) different segments of automated turn 900, in some disclosed embodiments. For instance, a first automated segment 920 can begin at an initial heading measured in response to an operator input 430. In conjunction with the first segment, a disclosed power equipment control unit can turn OPE 420 according to a first function defining a first path embodying first automated segment 920. As automated turn 900 progresses along first automated segment 920, a change in heading relative to the initial heading (or relative an absolute heading) can be monitored with respect to a (first) stored change in heading (or stored absolute heading). Once the change in heading reaches the stored change in heading (e.g., 120 degrees from the initial heading, or any other suitable range or value between 0 degrees and a final direction of automated turn 900), the first automated segment 920 can end and a second automated segment 922 can begin. The second automated segment 922 can be defined by the first stored change in heading and a second stored change in heading. In addition, the disclosed power equipment control unit can turn OPE 420 according to a second function defining a second path embodying second automated segment 922. As automated turn 900 progresses along second automated segment 922, the change in heading can continue to be measured from the initial heading (or in an alternative embodiment can be measured from the first stored change in heading) with respect to a second stored change in heading. Once the change in heading reaches the second stored change in heading, the disclosed power equipment control unit can end second automated segment 922.

If second automated segment 922 is the final segment of multi-segment automated turn 900 (e.g., as shown in the embodiment illustrated by FIG. 9), automated turn 900 can end and the power equipment control unit can stop all control over a steering apparatus of OPE 420. This reverts control of the steering apparatus of OPE 420 exclusively to the operator of OPE 420. Otherwise, multi-segment automated turn 900 can begin a subsequent automated turn segment (not depicted) and the disclosed power equipment control unit can turn OPE 420 according to a subsequent function defining a subsequent path embodying the subsequent automated turn segment. This sequence can continue until the final segment of multi-segment automated turn 900 is complete and the power equipment control unit stops controlling steering apparatus of OPE 420.

In various embodiments, a calculated (or estimated) displacement parameter value can be utilized instead of or in conjunction with heading measurements described above. As one example, in response to operator input 430 an initial (relative) position can be defined as a start of first automated segment 920. In addition, the power equipment control unit can control a steering apparatus of OPE 420 according to the first function defining the first path (or a different first function defining another suitable path from that depicted) and average velocity can be calculated and used to estimate displacement from the initial position over time. Once the estimated displacement reaches a first stored displacement value, the first automated segment 920 can end and second automated segment 922 (or a second automated segment different from that shown in FIG. 9) can be implemented. A second function defining the second path is utilized for controlling the steering apparatus of OPE 420 and displacement can continue to be estimated (from the initial position, or optionally from the first stored displacement value) and compared with a second stored displacement value. Once the second stored displacement value is reached, second automated segment 922 can end. If second automated segment 922 is the final segment, the power equipment control unit can terminate control over a steering apparatus of OPE 420, restoring exclusive control to an operator thereof. Otherwise, a subsequent automated segment (not depicted) can be implemented until the final segment is completed.

As introduced previously, multi-segment automated turn 900 can employ a combination of heading and displacement for defining a portion of one or more segments of multi-segment automated turn 900. As an example, a first segment can be begun with an initial heading and terminated when a subsequent heading meets a stored threshold heading, and a second segment can begin with an initial (relative) position determined concurrent with termination of the first segment and terminated when displacement from the initial position reaches a stored threshold displacement. As another example, the reverse can be implemented: the first segment can begin with an initial position in response to operator input 430 and can end in response to an estimated displacement from the initial position meeting a stored displacement threshold. A heading measured concurrent with termination of the first segment can begin the second segment, which continues until a stored threshold heading value is achieved to terminate the second segment, and so on. Each segment can be associated with a function defining a curve, with a fixed steering angle (or sequence of angles), or with a variable angle, as suitable. In the embodiment depicted by FIG. 9, OPE 420 begins at an initial line 910 and turns at a first constant radius during first automated segment 920 and turns at a second constant radius during second automated segment 922 until the automated turn ends and subsequent line 912 begins.

In still further embodiments, a segment of multi-segment automated turn 900 can begin with either an initial heading or initial position (or both) and can terminate in response to either a threshold displacement being reached or a threshold heading being measured, whichever is first. As an example, second automated segment 922 can begin when a stored heading value is reached while OPE 420 is traversing first automated segment 920. An initial position for OPE 420 can be correlated with the beginning of second automated segment 922, and both displacement from the initial position and change in heading from the stored heading value (or an initial heading) can be monitored relative to respective stored parameters. When a stored displacement is ended, second automated segment 922 can end, or when a second stored heading is measured second automated segment 922 can also end, whichever is determined first. Similarly, in other embodiments, second automated segment 922 can begin when a stored displacement from operator input 430 is determined, and change in heading as well as additional displacement from the start of second automated segment 922 can be monitored and second automated segment 922 can end in response to the heading or the displacement reaching respective termination values. Other suitable combinations of the foregoing known in the art or reasonably conveyed to one of ordinary skill in the art by way of the context provided herein is considered to be within the scope of the present disclosure.

FIG. 9A illustrates a multi-segment automated turn 900A according to alternative embodiments of the present disclosure. Automated turn 900A can be substantially the same as multi-segment automated turn 900 described above, except implemented in a different direction. A direction selection can be communicated as part of operator input 930A in one more disclosed embodiments, and can be a binary selection specifying a left direction or a right direction turn, although the subject disclosure is not limited to such an implementation.

Beginning at initial line 910A OPE 420 can receive an operator input 930A at a user input/output device. Operator input 930A can be an electronic or computer-controlled input such as a button press, turn of a knob, flip of a switch, input on a digital display, or the like. Moreover, operator input 930A can be separate from (and optionally in addition to) a steering, drive or brake control of OPE 420. Operator input 930A can also include a direction element indicating a right turn direction (in contrast to a direction element indicating a left turn direction as illustrated in FIG. 9, supra).

In response to operator input 930A OPE 420 begins a first automated segment 920A until a stored heading or displacement value is reached. At such point, first automated segment 920A ends and a second automated segment 922A begins. OPE 420 can be controlled according to a first turning function during first automated segment 920A and according to a second turning function during second automated segment 922A. Second automated segment 922A can end when a second stored heading or displacement value is reached. A subsequent segment of multi-segment automated turn 900A can then commence, in some embodiments, or if second automated segment 922A is a final segment of multi-segment automated turn 900A as shown in FIG. 9A, multi-segment automated turn 900A can then end at subsequent line 912A, as shown.

FIG. 10 depicts a diagram of an example multi-segment automated turn 1000 according to still further embodiments of the present disclosure. Multi-segment automated turn 1000 more distinctly illustrates the change in path from a first automated segment 1020 to an automated low radius turn segment 1024. As shown, multi-segment automated turn 1000 begins in response to an operator input 930. First automated segment 1020 begins. In an embodiment, first automated segment 1020 can involve a constant radius turn (or substantially constant radius turn) for its duration. As shown at path re-direct 1022, automated low radius turn segment 1024 begins. A discontinued path of first automated segment 1020 shows the spatial divergence of an outdoor power equipment device located on automated low radius turn segment 1024 after path redirect 1022. Automated low radius turn segment 1024 can end after a heading (or a displacement, or both) of the outdoor power equipment device is measured at an angle selected from a range of exit angles 1026. Range of exit angles can be an angle selected from about 160 degrees to about 200 degrees from an initial heading of the outdoor power equipment device at operator input 930, in some embodiments. In other embodiments, range of exit angles can be an angle selected from about 170 degrees to about 190 degrees from the initial heading. In at least one embodiment, range of exit angles can be about 180 degrees from the initial heading. In still further embodiments, range of exit angles can be a target that triggers termination of automated low radius turn segment 1024 in response to the heading of outdoor power equipment device being measured anywhere within (or exceeding) range of exit angles 1026.

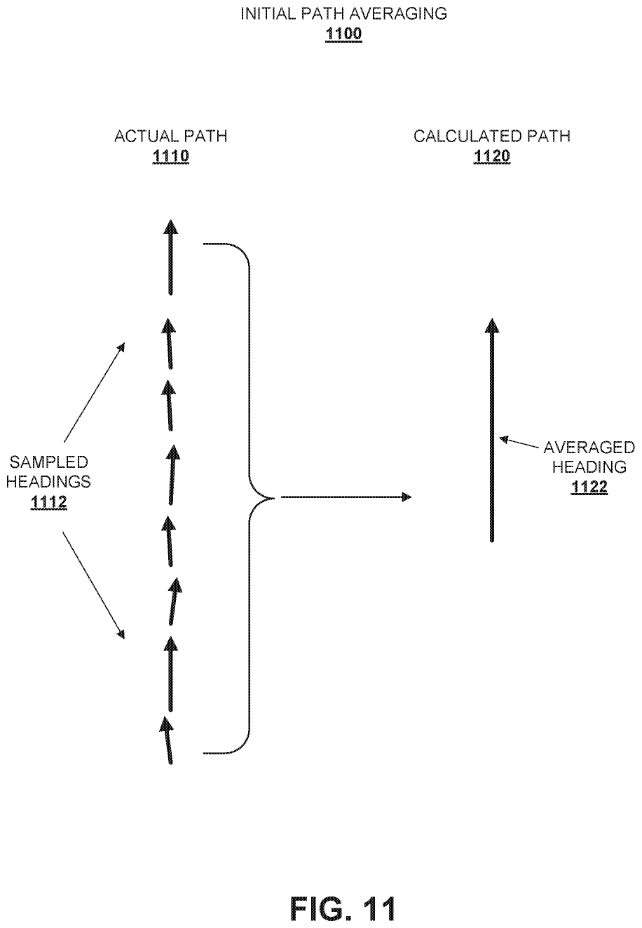

FIG. 11 depicts a diagram of initial path averaging according to alternative or additional embodiments of the present disclosure. Shown is an actual path 1110 comprising a set of sampled headings 1112. Sampled headings 1112 can correspond to periodic gyroscope measurements of a power equipment device while moving along actual path 1110, as an illustrative example. It should be understood that actual path 1110 can be substituted for other paths shown (or implied) to be straight-line paths, such as initial line 910 or initial line 910A or other analogous examples (e.g., current path 405, outbound path 732, etc.). In implementation, sampled headings 1112 can be a set of previous heading measurements recorded by a disclosed power equipment control unit (or equipment state and location estimator 304, as suitable) and stored to approximate a path recently traveled by the power equipment device. In response to an operator input initiating an automated turn as disclosed herein, the set of previous heading measurements can be utilized to generate (or approximate) a heading of the power equipment device. This can mitigate or avoid anomalous heading measurements that might occur as an operator provides the operator input to initiate the automated turn. Described differently, instead of determining a heading at a single point in time, the heading can be determined from multiple prior heading measurements to avoid a single anomalous heading measurement concurrent with initiation of the automated turn causing the automated turn to progress too far (or too short) along a path of the turn. By defining actual path 1110 with multiple prior measurements a more accurate initial heading of an initial line (e.g., 910, 910A) can be obtained, reducing the likelihood of a subsequent line (e.g., 912, 912A) being in an unexpected direction.

To this end, heading measurements of an actual path 1110 can be computed into a calculated path 1120. One example mechanism for determining calculated path 1120 is simply to average individual sampled headings 1112 to generate an averaged heading 1122, and use averaged heading 1122 as calculated path 1120. In some embodiments, a subset of sampled headings 1112 can be employed to determine averaged heading 1122. For instance, a mean heading can be determined from sampled headings 1112 and any single heading measurement diverging more than a stored amount from the mean heading can be discarded from averaged heading 1122. In other examples, the largest deviation in a first direction (e.g., greater than the mean) and the largest deviation in an opposite direction (e.g., smaller than the mean) can be discarded and averaged heading 1122 can be calculated from remaining sampled headings 1112. Other mechanisms for filtering or selectively discarding sampled headings 1112 in conjunction with determining averaged heading 1122 can be employed, including those known in the art of statistical sampling and calculation or reasonably conveyed to one of ordinary skill in such art by way of the context provided herein.

Generally, the illustrated embodiments disclosed herein are not provided as strict limitations on how the disclosed aspects can be practiced by one of ordinary skill in the art, but are intended to be provided as examples that can be modified, interchanged, added to or subtracted from as would be suitable to one of ordinary skill in the art. As an example, an arrangement of components depicted in one embodiment can be swapped with components depicted in another embodiment, optionally excluding some components or including other components illustrated in a third embodiment, according to design creativity of one of ordinary skill in the art. For instance, control unit 102, positioning/orientation device 230 and direction control system 220 of FIG. 2 can be incorporated within FIG. 3 as contained within power equipment control unit 302 or optional GUI app and input/output 322, or as communicatively connected with equipment state and location estimator 304, as suitable. As a further example, components of disclosed devices can be implemented as external to and communicatively or operably connected to other components of a parent device, rather than included within the parent device. For instance, motor drive 108 can be external to control unit 102 and communicatively connected thereto instead of implemented as a component thereof. Alternatively, the opposite orientation can be implemented within the scope of the disclosure: one component (e.g., auto-turn module 324) depicted separate from another component (e.g., equipment state and location estimator 304, or power equipment control unit 302) can be aggregated as a single component in some embodiments. Embodiments or portions thereof depicted in one Figure can be exchanged with or incorporated with embodiments depicted in other Figures; embodiments or portions thereof in the one Figure can be combined with the other Figure(s), and the like as would be suitable to one of ordinary skill in the art, or reasonably conveyed to one of ordinary skill in the art by way of the context provided herein. Additionally, it is noted that one or more disclosed processes can be combined into a single process providing aggregate functionality. Furthermore, components of disclosed machines/devices/sensors/control units can also interact with one or more other components not specifically described herein but known by those of skill in the art.

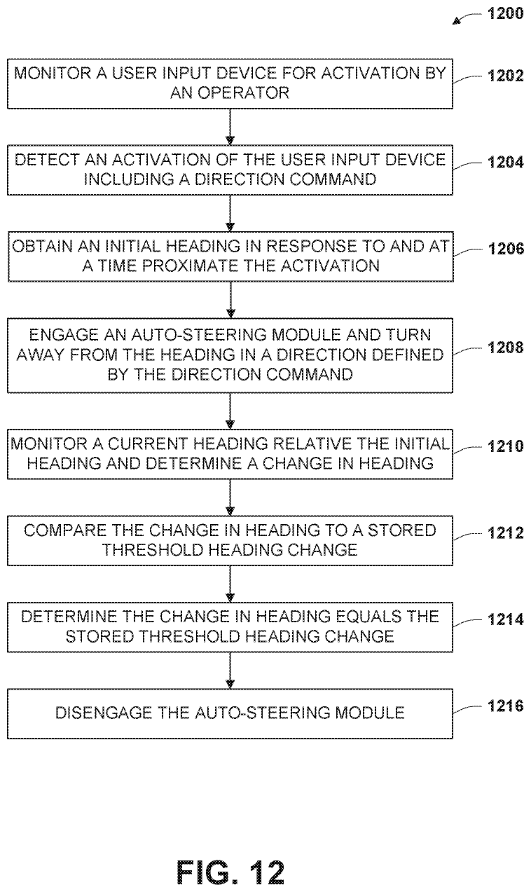

In view of the exemplary diagrams described herein, process methods that can be implemented in accordance with the disclosed subject matter will be better appreciated with reference to the flowchart of FIGS. 12 and 13. While for purposes of simplicity of explanation the methods of FIGS. 12 and 13 are shown and described as a series of blocks, it is to be understood and appreciated that the scope of the disclosure and the claimed subject matter is not limited by the order of the blocks, as some blocks can occur in different orders or concurrently with other blocks from what is depicted and described herein. Moreover, not all illustrated blocks are necessarily required to implement the methods described herein. Additionally, it should be further appreciated that some or all the methods disclosed throughout this specification are capable of being stored on an article of manufacture to facilitate transporting and transferring such methods to an electronic device. The term article of manufacture, where utilized, is intended to encompass a computer program accessible from any computer-readable device, device in conjunction with a carrier, or storage medium.

FIG. 12 illustrates a flowchart of an example method 1200 for limited autonomous operator assistance in turning a power equipment device according to one or more embodiments of the present disclosure. At 1202, method 1200 can comprise monitoring a user input device of a lawn maintenance apparatus for an activation of the user input device. The activation can be an input by a user input device, such as a press of a button, turn of a knob or dial, a touch on a display screen, and so forth.

At 1204, method 1200 can comprise detecting an activation of the user input device. The activation can include a direction command, in various embodiments. As examples, the direction command can indicate a left-of-heading turn or a right-of-heading turn, or other suitable turning definition. At 1206, method 1200 can comprise obtaining an initial heading of a heading measurement apparatus in response to detecting the activation of the user input device. The obtaining the initial heading of the heading measurement apparatus can be at a time proximate the detection of the activation of the user input device. In various embodiments, a time proximate can be defined as within a number of clock cycles from detecting the activation, e.g., less than one hundred clock cycles from detecting the activation, less than one thousand clock cycles, less than ten thousand clock cycles, or other suitable value or range of clock cycles. In an alternative embodiment, the time proximate can be defined as within a number of program cycles (defined, e.g., as a proportional-integral-derivative (P-I-D) loop, or the like), such as 1 to 100 program cycles covering about one millisecond to about one tenth of a second. In other embodiments, proximate can be less than a millisecond, less than a tenth of a second, less than half a second, less than a second, less than two to three seconds or less than three to five seconds following the detecting the activation of the user input device, in various embodiments.

At 1208, method 1200 can comprise engaging an auto-steering module of the lawn maintenance apparatus and turn the lawn maintenance apparatus into a direction specified by the direction command. In one or more embodiments, turning the lawn maintenance apparatus can comprise turning the lawn maintenance apparatus with a turn radius that is not equal to a track width of the lawn maintenance apparatus. At 1210, method 1200 can comprise monitoring a current heading of the lawn maintenance apparatus relative to the initial heading as the auto-steering module turns the lawn maintenance apparatus and determining a contemporaneous change in heading during the turn.

At 1212, method 1200 can further comprise comparing the contemporaneous change in heading to a stored threshold heading change relative to the initial heading. At 1214, method 1200 can additionally comprise determining the contemporaneous change in heading has become equal to or exceeds the stored threshold heading change, and at 1216 method 1200 can comprise disengaging the auto-steering module.

In some embodiments of the present disclosure, the turn radius of the turning the lawn maintenance apparatus can be greater than but not equal to the track width of the lawn maintenance apparatus. In further embodiments, the turn radius of the turning of the lawn maintenance apparatus can be less than but not equal to the track width of the lawn maintenance apparatus.

In another embodiment, the stored threshold heading change can be within a range from about 170 degrees to about 190 degrees from the initial heading. Moreover, disengaging the auto-steering module can be in response to the contemporaneous change in heading being determined to equal or exceed the stored threshold heading change.

In an additional embodiment, engaging the auto-steering module of the lawn maintenance apparatus can further comprise activating an electric motor coupled to a drive shaft of the lawn maintenance apparatus. In addition, method 1200 can comprise providing a turning signal to the electric motor causing the electric motor to turn the drive shaft to a fixed angle that corresponds to the turn radius. In an alternative embodiment, engaging the auto-steering module can further comprise activating a motor coupled to a wheel orientation mechanism of a steering ground wheel of the lawn maintenance apparatus. Method 1200 can further comprise providing the turning signal to the motor causing the motor to turn the wheel orientation mechanism of the steering ground wheel a fixed angle that corresponds to the turn radius. In still another alternative embodiment, engaging the auto-steering module further comprises activating a relative motor output controller. Activating the relative motor output controller can be configured to generate a right wheel speed signal and output the right wheel speed signal to a right drive wheel motor of the lawn maintenance apparatus to rotate a right drive wheel at a first rotational speed. Activating the relative motor output controller can further be configured to generate a left wheel speed signal of different magnitude than the right wheel speed signal and output the left wheel speed signal to a left drive wheel motor of the lawn maintenance apparatus to rotate a left drive wheel at a second rotational speed, wherein a difference between the first rotational speed and the second rotational speed is selected to turn the lawn maintenance apparatus into the direction at the turn radius.

In further embodiments of the present disclosure, method 1200 can further comprise monitoring an operator steering input device during engagement of the auto-steering module for an activation of the operator steering input device. Method 1200 can further comprise disengaging the auto-steering module prior to determining the contemporaneous change in heading has become equal to or exceeds the stored threshold heading change in response to identifying the activation of the operator steering input device.

In addition to the foregoing, method 1200 can further comprise, in response to determining the contemporaneous change in heading has become equal to or exceeds the stored threshold heading change, terminating the turning the lawn maintenance apparatus at the turn radius and steer, by way of the auto-steering module, to a low radius turn into the direction specified by the direction command. In one or more embodiments, the low radius turn can be different from the turn radius and defined by a second turn radius that is less than the track width of the lawn maintenance apparatus. As one example, the low radius turn can be less than one half the track width of the lawn maintenance apparatus. In other examples, the low radius turn can be a zero radius turn, or can have a radius within a range from: smaller than the track width to zero radius.

In addition to the foregoing, method 1200 can additionally comprise continuing monitoring the current heading of the lawn maintenance apparatus during the low radius turn relative to the initial heading and determining the contemporaneous change in heading. Further, method 1200 can comprise comparing the contemporaneous change in heading during the low radius turn to a second stored threshold heading change, and determine the contemporaneous change in heading has become equal to or exceeds the second stored threshold heading change. In various embodiments, disengaging the auto-steering module is in response to determining the contemporaneous change in heading has become equal to or exceeds the second stored threshold heading change. In further embodiments, the stored threshold heading change can be within a first range from about 60 degrees to about 150 degrees from the initial heading, and the second stored threshold heading change can be within a second range from about 150 degrees to about 190 degrees from the initial heading.

FIG. 13 illustrates a flowchart of an example method 1300 according to still other embodiments of the present disclosure. At 1302, method 1300 can comprise receiving an activation of a user input device by an operator of a power equipment machine. At 1304, method 1300 can comprise obtaining an initial heading of the power equipment machine in response to the activation and, at 1306, method 1300 can comprise engaging an auto-steering module and turning the power equipment machine in a direction away from the heading. The direction (e.g., left of the initial heading, right of the initial heading, or other suitable representation of orientation) can be determined from the activation of the user input device, in various embodiments.

At 1308, method 1300 can comprise monitoring a current heading relative to the initial heading and determining a change in the heading. At 1310, method 1300 can comprise comparing the change in heading to a stored threshold heading change, and at 1312, method 1300 can further comprise determining the change in heading equals the stored threshold heading change in one or more disclosed embodiments.

At 1314, method 1300 can comprise engaging the auto-steering module and turning the power equipment machine into a low radius turn in response to determining the change in heading equals the stored threshold heading change. At 1316, method 1300 can comprise comparing the change in heading to a second stored threshold heading change during the low radius turn and at 1318, method 1300 can comprise determining the change in heading equals the second stored threshold heading change. At 1320, method 1300 can comprise stopping the low radius turn in response to determining the change in heading equals the second stored threshold heading change, and at 1322 method 1300 can comprise deactivating the auto-steering module. Deactivating the auto-steering module can optionally be in response to and concurrent with determining the change in heading equals the second stored threshold heading change.

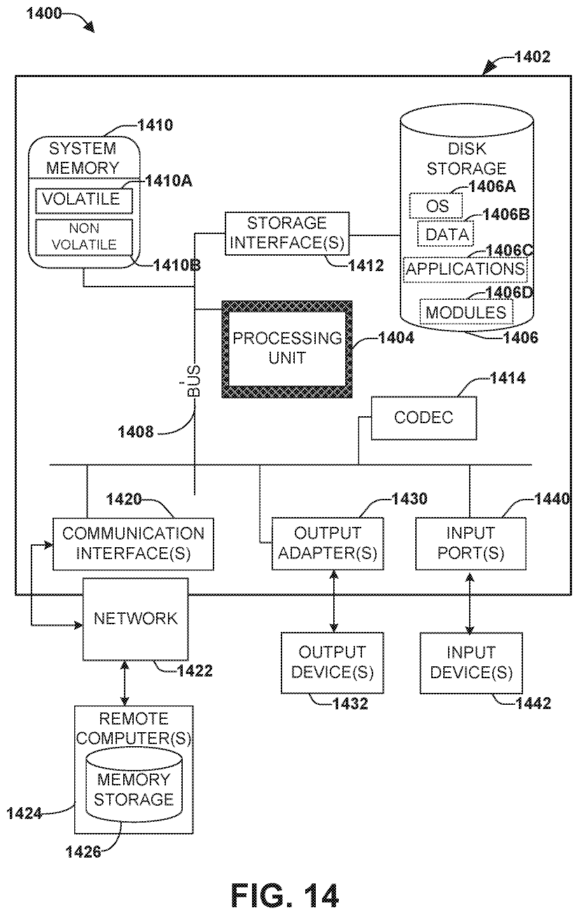

In connection with FIG. 14, the systems and processes described below can be embodied within hardware, such as a single integrated circuit (IC) chip, multiple Ics, an application specific integrated circuit (ASIC), or the like. A suitable operating environment 1400 for implementing various aspects of the claimed subject matter includes a computer 1402. In various embodiments, a control unit (e.g., control unit 102, power equipment control unit 302, and so forth) of a power equipment device can be embodied in part by computer 1402, or an analogous computing device known in the art, subsequently developed, or made known to one of ordinary skill in the art by way of the context provided herein.

The computer 1402 includes a processing unit 1404, a system memory 1410, a codec 1414, and a system bus 1408. The system bus 1408 couples system components including, but not limited to, the system memory 1410 to the processing unit 1404. The processing unit 1404 can be any of various available processors. Dual microprocessors and other multiprocessor architectures also can be employed as the processing unit 1404.

The system bus 1408 can be any of several types of bus structure(s) including the memory bus or memory controller, a peripheral bus or external bus, or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1410 can include volatile memory 1410A, non-volatile memory 1410B, or both. Functions of control unit 102 (among other control units: 302, depicted herein) described in the present specification can be programmed to system memory 1410, in various embodiments. The basic input/output system (BIOS), containing the basic routines to transfer information between elements within the computer 1402, such as during start-up, is stored in non-volatile memory 1410B. In addition, according to present innovations, codec 1414 may include at least one of an encoder or decoder, wherein the at least one of an encoder or decoder may consist of hardware, software, or a combination of hardware and software. Although codec 1414 is depicted as a separate component, codec 1414 may be contained within non-volatile memory 1410B. By way of illustration, and not limitation, non-volatile memory 1410B can include read only memory (ROM), programmable ROM (PROM), electrically programmable ROM (EPROM), electrically erasable programmable ROM (EEPROM), or Flash memory. Non-volatile memory 1410B can be embedded memory (e.g., physically integrated with computer 1402 or a mainboard thereof), or removable memory. Examples of suitable removable memory can include a secure digital (SD) card, a compact Flash (CF) card, a universal serial bus (USB) memory stick, or the like. Volatile memory 1410A includes random access memory (RAM), which can serve as operational system memory for applications executed by processing unit 1404. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM), and so forth.

Computer 1402 may also include removable/non-removable, volatile/non-volatile computer storage medium. FIG. 14 illustrates, for example, disk storage 1406. Disk storage 1406 includes, but is not limited to, devices such as a magnetic disk drive, solid state disk (SSD) floppy disk drive, tape drive, Flash memory card, memory stick, or the like. In addition, disk storage 1406 can include storage medium separately or in combination with other storage medium including, but not limited to, an optical disk drive such as a compact disk ROM device (CD-ROM) or derivative technology (e.g., CD-R Drive, CD-RW Drive, DVD-ROM, and so forth). To facilitate connection of the disk storage 1406 to the system bus 1408, a removable or non-removable interface is typically used, such as interface 1412. In one or more embodiments, disk storage 1406 can be limited to solid state non-volatile storage memory, providing motion and vibration resistance for a control unit (e.g., control unit 102, among others) operable in conjunction with a power equipment device (e.g., power equipment device 300, etc.).

It is to be appreciated that FIG. 14 describes software that can program computer 1402 to operate as an intermediary between an operator of a power equipment device (e.g., power equipment device 300, and others), or operate as an intermediary between the power equipment device and an autonomous steering system (or partially autonomous, user-assisted steering system) for operating the power equipment device embodied within operating environment 1400. Such software includes an operating system 1406A. Operating system 1406A, which can be stored on disk storage 1406, acts to control and allocate resources of the computer 1402. Applications 1406C take advantage of the management of resources by operating system 1406A through program modules 1406D, and program data 1406B, such as the boot/shutdown transaction table and the like, stored either in system memory 1410 or on disk storage 1406. It is to be appreciated that the claimed subject matter can be implemented with various operating systems or combinations of operating systems.

Input device(s) 1442 connects to the processing unit 1404 and facilitates operator interaction with operating environment 1400 through the system bus 1408 via interface port(s) 1430. Input port(s) 1440 can include, for example, a serial port, a parallel port, a game port, a universal serial bus (USB), among others. Output device(s) 1432 can use some of the same type of ports as input device(s) 1442. Thus, for example, a USB port may be used to provide input to computer 1402 and to output information from computer 1402 to an output device 1432. Output adapter 1430 is provided to illustrate that there are some output devices, such as graphic display, speakers, and printers, among other output devices, which require specific or custom adapters. The output adapter 1430 can include, by way of illustration and not limitation, video and sound cards that provide a means of connection between the output device 1432 and the system bus 1408. It should be noted that other devices or systems of devices provide both input and output capabilities such as remote computer(s) 1424 and memory storage 1426.

Computer 1402 can operate in conjunction with one or more electronic devices described herein. For instance, computer 1402 can embody a power equipment control unit 302 configured to operate steering, drive and brake system 308 to provide user-assisted steering along a curved path(s), as described herein. Additionally, computer 1402 can communicatively couple with equipment state and location estimator 304, etc., auto-turn module 324 or user input/output module 320, among other disclosed components and devices to generate steering data to maintain the curved path(s), including heading measurements or estimated displacement values of a power equipment device. Computer 1402 can communicatively couple with various disclosed components by way of a network interface 1422 (e.g., a wireless network interface, a wired network interface, a global positioning system (GPS) interface, and so forth), in an embodiment. In other embodiments, network interface 1422 can be a local network interface interconnecting electronic components located exclusively at a power equipment device (e.g., power equipment device 300).

Communication connection(s) 1420 can refer to the hardware/software employed to connect the network interface 1422 to the system bus 1408. Network interface 1422 can be a non-wireless network interface in some embodiments, interconnecting devices positioned on a disclosed power equipment device only. While communication connection 1420 is shown for illustrative clarity inside computer 1402, it can also be external to computer 1402. In at least some disclosed embodiments, the hardware/software necessary for connection to the network interface 1422 can include, for exemplary purposes only, internal and external technologies such as, modems including regular telephone grade modems, cable modems and DSL modems, ISDN adapters, and wired and wireless Ethernet cards, hubs, and routers.

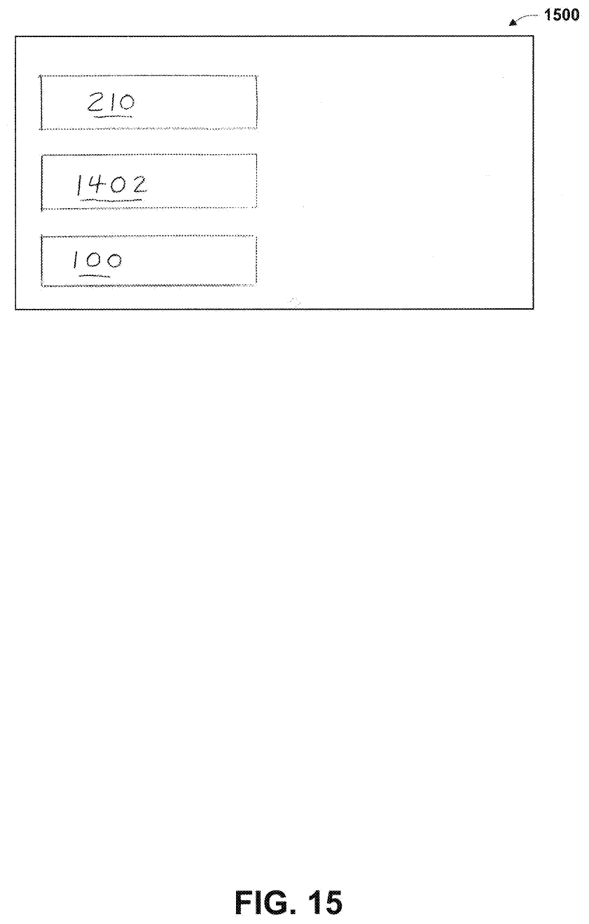

Further to the above, and in reference now to FIG. 15, in some aspects the subject matter herein may pertain to an automatic turning and recording module for an outdoor power equipment device. In a first aspect pertaining to an automatic turning and recording module 1500 for an outdoor power equipment device 420, (hereafter, “the first aspect”) the automatic turning and recording module 1500 comprises a user input 210, first computer 1402, and a steering controller 100.

In the first aspect, the user input 210 may generally comprise the same or similar features and components and capabilities described above in association with other aspects. In the first aspect the user input 210 is configured for receiving an operator turn command related to turning the outdoor power equipment device 420 and a direction for turning the outdoor power equipment device. Also, in the first aspect, the user input 210 is configured for receiving an operator record command causing creation of a record of operator turn command data where the record of operator turn command data is sufficient to create an emulation of the operator turn command related to turning the outdoor power equipment device and the direction for turning the outdoor power equipment device. The recorded data may comprise, but is not limited to, an encoder count for each of the drive wheels, time, position in three dimensions, orientation in three dimensions, velocity in three dimensions, angular velocity in three dimensions, acceleration in three dimensions, angular acceleration in three dimensions, jerk in three dimensions, angular jerk in three dimensions, position of castors about a steer axis, or some combination thereof. It should be understood that the emulation of the command, may be in some embodiments a signal for signal duplicate of the operator turn command but this is not the only functional embodiment and alternatives are contemplated. For example, the emulation may filter the operator turn command data to remove noise or to simplify the data to produce an emulation that takes less data to describe but that yields a result that is substantially the same. Filtering of the operator turn command data is optional, but in those embodiments using filtering, the type of filter used to filter the operator turn command data may comprise, in some non-limiting embodiments, low-pass, band pass, moving average, exponential, Kalman, IIR, FIR, or other type of filter chosen with good engineering judgment. Similarly to the latter filtration, the operator turn command data may be subjected to some sort of data compression before being stored or used by an emulation. Such data compression may include trimming of the data or use of compression algorithms. By way of another example, and as will be addressed further herebelow, it is contemplated that the record of operator turn command data may permit an associated user to record a series of commands that when concatenated form a compound turn such as, and without limitation, a K-turn, or a Y-turn, or a U-turn, or some other compound turn. The series of commands to be concatenated may each describe a part of the desired compound turn that may further form a discontinuity in the turn path at their conjunction points when connected as taught. In some embodiments, such as, and without limitation in a U-turn, it may be simpler and/or more desirable for the emulation to smooth the latter referenced discontinuities in order to reduce, minimize, or eliminate acceleration or jerk [herein, “jerk” refers to d(acceleration)/d(time)]. In some embodiments, it may be desirable to create an emulation using computational standards that limit velocity, acceleration or jerk to some pre-set maximum, such as one that is set by an associated user, or to a maximum determined by some formula.

In the first aspect, the first computer 1402 may generally comprise the same or similar features and components and capabilities described above in association with other aspects. In the first aspect, the first computer 1402 is communicatively coupled to the user input 210, is configured to receive the operator record command from the user input 210, is configured to create the record of operator turn command data, is configured to create the emulation of the operator turn command based on the record of the operator turn command data, and is configured to output the emulation. In some optional aspects the computer 1402 is adapted to perform the above-referenced concatenation of turn commands, or smoothing of discontinuities, limiting of acceleration, limitation of jerk, or other calculations, adjustments, and filtering of data to produce the emulation. It should be understood that in some aspects the emulated turn produced defines a path to be followed at some set of velocity, acceleration, and jerk at any given point on the path where each of the velocity, acceleration, and jerk may vary with time or position. In some non-limiting embodiments, the latter path or subsections of the path may be defined by curve fitting where the curve fitting may comprise: a best fit curve to a polynomial of nth degree (including a polynomial defining a line), a best fit curve to a sinusoidal function, a best fit curve to a semicircular arc, a best fit curve to an elliptical arc, or otherwise as chosen with good engineering judgment. In some non-limiting embodiments, the latter path or subsections of the path may be defined by some combination of the latter curve fittings such as a concatenation of arc segments or a concatenation of best fit function segments.

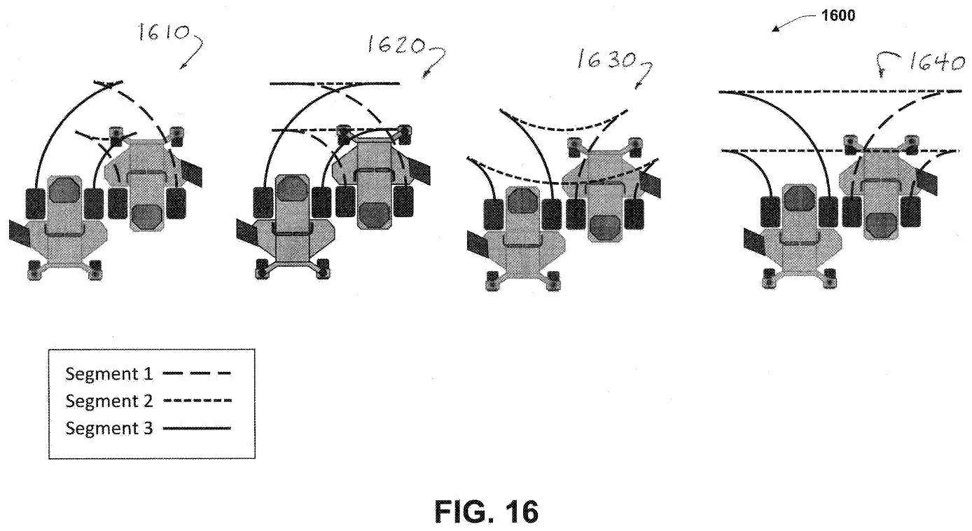

With reference now to FIG. 16, shown is a series of images 1600 showing possible turns that may be recorded and automatically emulated. Referring to the image sets of FIG. 16 from left to right, the first image set 1610 shows a three-segment compound turn for power equipment device 300 proceeding forward along leftward turn (from the view of a user seated thereon) indicated by the Segment 1 large dashes; stopping; reversing along the curved path indicated by the Segment 2 short dashes; stopping; proceeding forward along the leftward turn indicated by the Segment 3 solid line. In full the three-segment turn of the first image set reorients the power equipment device 300 by 180 degrees within a small spatial region onto a parallel track. Referring again to FIG. 16 and the image sets therein from left to right, the second image set 1620 shows a three-segment turn for power equipment device 300 proceeding forward along a leftward turn (from the view of a user seated thereon) indicated by the Segment 1 large dashes; stopping; reversing along the straight path indicated by the Segment 2 short dashes; stopping; proceeding forward along the leftward turn indicated by the Segment 3 solid line. In full the three-segment turn of the second image set reorients the power equipment device 300 by 180 degrees within a small spatial region onto a parallel track. It should be noted that in each of the first image set and the second image set, the turn presents the output chute discharges away from the spatial region of the turn. Referring again to FIG. 16 and the image sets therein from left to right, the third image set 1630 shows a three-segment turn for power equipment device 300 proceeding forward along a rightward turn (from the view of a user seated thereon) indicated by the Segment 1 large dashes; stopping; reversing along the curved path indicated by the Segment 2 short dashes; stopping; proceeding forward along the rightward turn indicated by the Segment 3 solid line. In full the three-segment turn of the third image set reorients the power equipment device 300 by 180 degrees within a small spatial region onto a parallel track. Referring again to FIG. 16 and the image sets therein from left to right, the fourth image set 1640 shows a three-segment turn for power equipment device 300 proceeding forward along a rightward turn (from the view of a user seated thereon) indicated by the Segment 1 large dashes; stopping; reversing along the straight path indicated by the Segment 2 short dashes; stopping; proceeding forward along the rightward turn indicated by the Segment 3 solid line. In full the three-segment turn of the fourth image set reorients the power equipment device 300 by 180 degrees within a small spatial region onto a parallel track. It should be noted that in each of the third image set and the fourth image set, the turn presents the output chute discharges into the spatial region of the turn.

In the first aspect, the steering controller 100 may generally comprise the same or similar features and components and capabilities described above in association with other aspects. In the first aspect, the steering controller 100 is communicatively coupled to the computer 1402 and configured to receive the emulation therefrom. In the first aspect the steering controller comprises a computer, an orientation module, and a tracking module.

The computer of the steering controller may be either the above-referenced first computer 1402 of the first aspect, or may be a second computer; either is fine but for sake of simplicity the computer of the steering controller will be referred to henceforth as the steering controller computer. In the first aspect, the steering controller computer is configured for generating a series of turning signals based on the emulation. The latter series of turning signals has at least first turning signal and a last turning signal, which would be two turning signals, but the latter series of turning signals may have more than two turning signal: the latter series of turning signals may comprise 3, 4, 5, 6, 7, 8, 9, 10 20, 50 or more turning signals. The series of turning signals causes a steering apparatus of the outdoor power equipment device to move the outdoor power equipment device to execute a turn corresponding to the operator turn command.

In the first aspect, the orientation module may generally comprise the same or similar features and components and capabilities of the orientation determination system 115 described above in association with other aspects. In the first aspect, the orientation module is adapted to determine an instantaneous heading of the outdoor power equipment device. In the first aspect, local data is sufficient for the orientation module to determine an instantaneous heading. Without limitation, it should be understood that there are many devices for which local data is sufficient for the orientation module to determine an instantaneous heading including
a gyroscope; or a gyroscope in combination with an accelerometer; or a gyroscope in combination with a wheel encoder; or a gyroscope in combination with a speed estimation module; or a gyroscope and an accelerometer and a wheel encoder; or a gyroscope and an accelerometer and a speed estimation module; or a gyroscope and a wheel encoder and a speed estimation module; or a gyroscope and an accelerometer, and a wheel encoder, and a speed estimation module; or an accelerometer; or an accelerometer and a wheel encoder; or an accelerometer and a speed estimation module; or an accelerometer and a wheel encoder and a speed estimation module; or a wheel encoder; or a wheel encoder and a speed estimation module; or a speed estimation module.

In regard to the various functions performed by the above described components, machines, devices, processes and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments include a system as well as electronic hardware configured to implement the functions, or a computer-readable medium having computer-executable instructions for performing the acts or events of the various processes.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In other embodiments, combinations or sub-combinations of the above disclosed embodiments can be advantageously made. The block diagrams of the architecture and flow charts are grouped for ease of understanding. However, it should be understood that combinations of blocks, additions of new blocks, re-arrangement of blocks, and the like are contemplated in alternative embodiments of the present disclosure.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. An automatic module for an outdoor power equipment device, comprising:
a user input
configured for receiving an operator turn command related to turning the outdoor power equipment device and a direction for turning the outdoor power equipment device;
a first computer
communicatively coupled to the user input,
configured to access a stored record of operator turn command data,
configured to create an emulation of the operator turn command based on the record of an operator turn command data, and
to output the emulation; and
a steering controller communicatively coupled to the computer and configured to receive the emulation, the steering controller further comprising
a computer that may be either the first computer or a second computer configured for generating a series of turning signals based on the emulation, the series of turning signals having at least a first turning signal and a last turning signal, the series of turning signals causing a steering apparatus of the outdoor power equipment device to move the outdoor power equipment device to execute a turn corresponding to the operator turn command,
an orientation module adapted to determines an instantaneous heading of the outdoor power equipment device, wherein data local to the outdoor power equipment device is sufficient for the orientation module to determine an instantaneous heading, and
a tracking module configured to determine when the outdoor power equipment device has completed the turn corresponding to the operator turn command and to generate a turn completion signal when the turn corresponding to the operator turn command is completed.

2. The automatic module for an outdoor power equipment device of claim 1, wherein the user input is configured for receiving an operator record command causing creation of a record of operator turn command data where the record of operator turn command data is sufficient to create an emulation of the operator turn command related to turning the outdoor power equipment device and the direction for turning the outdoor power equipment device.

3. The automatic module for an outdoor power equipment device of claim 2, wherein the first computer is configured to
receive the operator record command;
create the record of operator turn command data; and
store the record of operator turn command data.

4. The automatic module for an outdoor power equipment device of claim 3, wherein the steering controller is communicatively coupled to the user input and configured to receive the operator turn command and the direction from the user input.

5. The automatic turning and recording module for an outdoor power equipment device of claim 4, wherein the computer that may be either the first computer or the second computer is the first computer.

6. The automatic module for an outdoor power equipment device of claim 5, wherein causing the steering apparatus of the outdoor power equipment device to move the outdoor power equipment device to execute the turn corresponding to the operator turn command comprises causing the steering apparatus of the outdoor power equipment device to move the outdoor power equipment device at a turn angle into the direction.

7. The automatic module for an outdoor power equipment device of claim 6, wherein the steering controller is configured to terminate generating the turning signals in response to generation of the turn completion signal by the tracking module and restore exclusive control of the steering apparatus to an operator of the outdoor power equipment device.

8. The automatic module for an outdoor power equipment device of claim 1, wherein the orientation module comprises a gyroscope, a gyroscope in combination with an accelerometer, a gyroscope in combination with a wheel encoder, or a gyroscope in combination with a speed estimation module, wherein the speed estimation module infers vehicle speed from a metric of prime mover power output.

9. The automatic module for an outdoor power equipment device of claim 1, wherein the orientation module comprises:
a gyroscope and an accelerometer and a wheel encoder; or
a gyroscope and an accelerometer and a speed estimation module; or
a gyroscope and a wheel encoder and a speed estimation module; or
a gyroscope and an accelerometer, and a wheel encoder, and a speed estimation module; or
an accelerometer; or
an accelerometer and a wheel encoder; or
an accelerometer and a speed estimation module; or
an accelerometer and a wheel encoder and a speed estimation module; or
a wheel encoder; or
a wheel encoder and a speed estimation module; or
a speed estimation module.

10. The automatic module for an outdoor power equipment device of claim 1, wherein the series of turning signals causes the steering apparatus of the outdoor power equipment device to move the outdoor power equipment device to execute a K-turn, or a Y-turn, or a U-turn.

11. The automatic module for an outdoor power equipment device of claim 8, wherein the series of turning signals causes the steering apparatus of the outdoor power equipment device to move the outdoor power equipment device to execute a turn,
where the turn is a K-turn, or a Y-turn, or a U-turn; and
wherein the turn has a turn speed that is a fixed turning speed less than 15 mph.

12. The automatic module for an outdoor power equipment device of claim 11, further comprising turning the outdoor power equipment device with a non-constant turn radius defined by an arc, a parabola, a polynomial function or a multi-radius curve.

13. A method for using an automatic module for an outdoor power equipment device, comprising:
providing a outdoor power equipment device with an automatic module having,
a user input
configured for receiving an operator turn command related to turning the outdoor power equipment device and a direction for turning the outdoor power equipment device,
a first computer
communicatively coupled to the user input,
configured to access a stored record of operator turn command data,
configured to create an emulation of the operator turn command based on the record of operator turn command data, and
to output the emulation, and
a steering controller communicatively coupled to the computer and configured to receive the emulation, the steering controller further comprising
a computer that may be either the first computer or a second computer configured for generating a series of turning signals based on the emulation, the series of turning signals having at least a first turning signal and a last turning signal, the series of turning signals causing a steering apparatus of the outdoor power equipment device to move the outdoor power equipment device to execute a turn corresponding to the operator turn command,
an orientation module adapted to determines an instantaneous heading of the outdoor power equipment device, wherein data local to the outdoor power equipment device is sufficient for the orientation module to determine an instantaneous heading, and
a tracking module configured to determine when the outdoor power equipment device has completed the turn corresponding to the operator turn command and to generate a turn completion signal when the turn corresponding to the operator turn command is completed;
creating the emulation of the operator turn command based the record of operator turn command data by using the first computer;
outputting the emulation to the steering controller;
generating a series of turning signals based on the emulation using the computer that may be either the first computer or the second computer; and
causing a steering apparatus of the outdoor power equipment device to move the outdoor power equipment device to execute a turn corresponding to the operator turn command.

14. The method for using an automatic module for an outdoor power equipment device of claim 13, wherein the user input is configured for receiving an operator record command causing creation of a record of operator turn command data where the record of operator turn command data is sufficient to create an emulation of the operator turn command related to turning the outdoor power equipment device and the direction for turning the outdoor power equipment device.

15. The method for using an automatic module for an outdoor power equipment device of claim 14, wherein the first computer is configured to
receive the operator record command;
create the record of operator turn command data; and
store the record of operator turn command data.

16. The method for using an automatic module for an outdoor power equipment device of claim 15, further comprising
inputting the operator record command to the user input;
sending the operator record command to the first computer;
inputting the operator turn command related to turning the outdoor power equipment device and a direction for turning the outdoor power equipment device; and
creating the record of operator turn command data by using the first computer.

17. The method for using an automatic module for an outdoor power equipment device of claim 13, wherein the steering controller is communicatively coupled to the user input and configured to receive the operator turn command and the direction from the user input.

18. The method for using an automatic module for an outdoor power equipment device of claim 17, wherein the computer that may be either the first computer or the second computer is the first computer.

19. The method for using an automatic module for an outdoor power equipment device of claim 18, wherein causing the steering apparatus of the outdoor power equipment device to move the outdoor power equipment device to execute the turn corresponding to the operator turn command comprises causing the steering apparatus of the outdoor power equipment device to move the outdoor power equipment device at a turn angle into the direction.

20. The method for using an automatic module for an outdoor power equipment device of claim 19, wherein the steering controller is configured to terminate generating the turning signals in response to generation of the turn completion signal by the tracking module and restore exclusive control of the steering apparatus to an operator of the outdoor power equipment device.

21. The method for using an automatic module for an outdoor power equipment device of claim 20, wherein the orientation module comprises a:
a gyroscope; or
a gyroscope in combination with an accelerometer; or
a gyroscope in combination with a wheel encoder; or
a gyroscope in combination with a speed estimation module; or
a gyroscope and an accelerometer and a wheel encoder; or
a gyroscope and an accelerometer and a speed estimation module; or
a gyroscope and a wheel encoder and a speed estimation module; or
a gyroscope and an accelerometer, and a wheel encoder, and a speed estimation module; or
an accelerometer; or
an accelerometer and a wheel encoder; or
an accelerometer and a speed estimation module; or
an accelerometer and a wheel encoder and a speed estimation module; or
a wheel encoder; or
a wheel encoder and a speed estimation module; or
a speed estimation module.

22. The method for using an automatic module for an outdoor power equipment device of claim 21, wherein the series of turning signals causes the steering apparatus of the outdoor power equipment device to move the outdoor power equipment device to execute a K-turn, or a Y-turn, or a U-turn.

23. The method for using an automatic module for an outdoor power equipment device of claim 22, further comprising turning the outdoor power equipment device with a non-constant turn radius defined by an arc, a parabola, a polynomial function or a multi-radius curve.

24. The method for using an automatic module for an outdoor power equipment device of claim 23, wherein the series of turning signals causes the steering apparatus of the outdoor power equipment device to move the outdoor power equipment device to execute a U-turn.

25. An automatic module for an outdoor power equipment device, comprising:
a user input
configured for receiving an operator turn command related to turning the outdoor power equipment device and a direction for turning the outdoor power equipment device, and
configured for receiving an operator record command causing creation of a record of operator turn command data where the record of operator turn command data is sufficient to create an emulation of the operator turn command related to turning the outdoor power equipment device and the direction for turning the outdoor power equipment device;
a first computer
communicatively coupled to the user input,
configured to receive the operator record command,
configured to create the record of operator turn command data, and
configured to create the emulation of the operator turn command based on the record of operator turn command data, and
to output the emulation;
a steering controller communicatively coupled to the computer and configured to receive the emulation, the steering controller further comprising
a second computer configured for generating a series of turning signals based on the emulation, the series of turning signals having at least a first turning signal and a last turning signal, the series of turning signals causing a steering apparatus of the outdoor power equipment device to move the outdoor power equipment device to execute a turn corresponding to the operator turn command,
an orientation module adapted to determines an instantaneous heading of the outdoor power equipment device, wherein data local to the outdoor power equipment device is sufficient for the orientation module to determine an instantaneous heading, and
a tracking module configured to determine when the outdoor power equipment device has completed the turn corresponding to the operator turn command and to generate a turn completion signal when the turn corresponding to the operator turn command is completed; and
wherein the steering controller is communicatively coupled to the user input and configured to receive the operator turn command and the direction from the user input;
wherein causing the steering apparatus of the outdoor power equipment device to move the outdoor power equipment device to execute the turn corresponding to the operator turn command comprises causing the steering apparatus of the outdoor power equipment device to move the outdoor power equipment device at a turn angle into the direction;
wherein the steering controller is configured to terminate generating the turning signals in response to generation of the turn completion signal by the tracking module and restore exclusive control of the steering apparatus to an operator of the outdoor power equipment device;
wherein the orientation module comprises a gyroscope, a gyroscope in combination with an accelerometer, a gyroscope in combination with a wheel encoder, or a gyroscope in combination with a speed estimation module, wherein the speed estimation module infers vehicle speed from a metric of prime mover power output;
wherein the series of turning signals causes the steering apparatus of the outdoor power equipment device to move the outdoor power equipment device to execute a K-turn, or a Y-turn.
